(19) United States
(12) Patent Application Publication
(10) Pub. No.: US 2025/0070240 A1
(43) Pub. Date: Feb. 27, 2025

(54) SOLID ELECTROLYTE COMPOSITION, ELECTRODE COMPOSITION, AND MANUFACTURING METHOD OF SOLID ELECTROLYTE COMPOSITION

(71) Applicant: Panasonic Intellectual Property Management Co., Ltd., Osaka (JP)

(72) Inventors: YASUTAKA TSUTSUI, Osaka (JP); TATSUYA OSHIMA, Osaka (JP)

(21) Appl. No.: 18/947,153

(22) Filed: Nov. 14, 2024

Related U.S. Application Data
(63) Continuation of application No. PCT/JP2023/009399, filed on Mar. 10, 2023.

(30) Foreign Application Priority Data
May 27, 2022 (JP) 2022-087266

(51) Int. Cl. H01M 10/0562; H01M 4/62; H01M 10/0525; H01M 10/0585

(52) U.S. Cl. CPC H01M 10/0562; H01M 4/62; H01M 10/0525; H01M 10/0585; H01M 2300/0068; H01M 2300/0091

(57) ABSTRACT

The solid electrolyte composition of the present disclosure includes a solid electrolyte and a dialkylamine-based dispersant. The dialkylamine-based dispersant is represented by the following compositional formula (1), wherein R¹ is a hydrocarbon group, and R² and R³ are each independently an alkyl group having 1 or more and 3 or less carbon atoms.

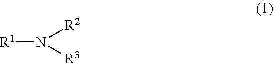

### BACKGROUND

### 1. Technical Field

The present disclosure relates to a solid electrolyte composition, an electrode composition, and a method for manufacturing a solid electrolyte composition.

### 2. Description of the Related Art

Japanese Unexamined Patent Application Publication No. 2016-212990 describes at least one layer of a positive electrode active material layer, a solid electrolyte layer, and a negative electrode active material layer contains a dispersant. Here, the dispersant is a compound having a functional group, such as a group containing a basic nitrogen atom, and an alkyl group having 8 or more carbon atoms or an aryl group having 10 or more carbon atoms.

International Publication No. WO 2020/136975 describes a battery material including a compound containing an imidazoline ring and an aromatic ring and having a molecular weight of less than 350.

Japanese Unexamined Patent Application Publication No. 2020-161364 describes a positive electrode produced by using slurry containing an acrylic resin binder and 1-hydroxyethyl-2-alkenylimidazoline.

### SUMMARY

In existing technology, technology for suppressing a decrease in the ion conductivity when a member of a battery is produced from a solid electrolyte composition has been desired.

In one general aspect, the techniques disclosed here feature a solid electrolyte composition including a solid electrolyte and a dialkylamine-based dispersant, wherein the dialkylamine-based dispersant is represented by the following compositional formula (1):

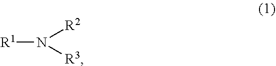

where, R¹ is a hydrocarbon group, and R² and R³ are each independently an alkyl group having 1 or more and 3 or less carbon atoms.

According to the present disclosure, it is possible to provide a solid electrolyte composition that is suitable for suppressing a decrease in the ion conductivity when a member of a battery is produced.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view of a solid electrolyte composition according to embodiment 1;

FIG. 2 is a schematic view of an electrode composition according to embodiment 2;

FIG. 3 is a flow chart showing a method for manufacturing a solid electrolyte sheet according to embodiment 3;

FIG. 4 is a cross-sectional view of an electrode assembly according to embodiment 3;

FIG. 5 is a cross-sectional view of a transfer sheet according to embodiment 3;

FIG. 6 is a cross-sectional view of an electrode according to embodiment 4;

FIG. 7 is a cross-sectional view of an electrode transfer sheet according to embodiment 4;

FIG. 8 is a cross-sectional view of a battery precursor according to embodiment 4; and

FIG. 9 is a cross-sectional view of a battery according to embodiment 5.

### DETAILED DESCRIPTIONS

### Underlying Knowledge Forming Basis of the Present Disclosure

In recent years, all-solid-state batteries have been extensively studied. In particular, a coating method, which can increase the size in manufacturing of an all-solid-state battery, is vigorously used. An all-solid-state battery is composed of a positive electrode, an electrolyte layer, and a negative electrode. The electrolyte layer is disposed between the positive electrode and the negative electrode. In detail, the electrolyte layer is disposed between a positive electrode layer and a negative electrode layer. The positive electrode is constituted of a positive electrode current collector and a positive electrode layer. The positive electrode current collector is constituted of metal foil. The positive electrode layer is obtained by, for example, applying an electrode composition containing a positive electrode active material, a solid electrolyte, a binder, and a dispersant to the positive electrode current collector and removing the solvent. The negative electrode is constituted of a negative electrode current collector and a negative electrode layer. The negative electrode current collector is constituted of metal foil. The negative electrode layer is obtained by, for example, applying an electrode composition containing a negative electrode active material, a solid electrolyte, a binder, and a dispersant to the negative electrode current collector and removing the solvent. The electrolyte layer is obtained by applying a solid electrolyte composition containing a solid electrolyte, a binder, and a dispersant to the positive electrode layer or the negative electrode layer and removing the solvent.

The dispersants included in the positive electrode, the negative electrode, and the electrolyte layer uniformly disperse, for example, the powder or particles included in these layers. Consequently, the characteristics of a battery can be improved, and a homogeneous positive electrode, a homogeneous negative electrode, and a homogeneous electrolyte layer can be formed. For example, the positive electrode includes a positive electrode active material particle, an active material particle of a type that is different from the type of the positive electrode active material particle, and multiple types of solid electrolyte particles. For example, the negative electrode includes a negative electrode active material particle, an active material particle of a type that is different from the type of the negative electrode active material particle, and multiple types of solid electrolyte particles. Dispersants can uniformly disperse these particles.

For example, the dispersibility of a particle such as the solid electrolyte included in the solid electrolyte composition is improved by adding a dispersant to a battery material such as a solid electrolyte composition. However, the ion conductivity of a solid electrolyte may decrease depending on the type of the binder and the type of the dispersant. The ion conductivity of a general binder or the ion conductivity of a dispersant is low, and the value thereof is approximate 0. Accordingly, the binder or the dispersant inhibits the ionic conduction of a solid electrolyte, which may deteriorate the characteristics of the battery. Accordingly, the ion conductivity of an electrolyte layer obtained from a solid electrolyte composition is contrarily decreased by uniformly dispersing a solid electrolyte, a binder, and a dispersant in the solid electrolyte composition,

Thus, it is necessary to suppress a decrease in the ion conductivity of an electrolyte layer obtained from a solid electrolyte composition containing a dispersant. The present inventors investigated ion conductivities of solid electrolyte sheets obtained from solid electrolyte compositions including dispersants. As a result, the present inventors found that according to a solid electrolyte sheet obtained from a solid electrolyte composition containing a specific dispersant, a decrease in the ion conductivity of the solid electrolyte can be suppressed. From the above viewpoints, the present inventors arrived at the composition of the present disclosure.

### Overview of One Aspect According to the Present Disclosure

A solid electrolyte composition according to a 1st aspect of the present disclosure includes:
a solid electrolyte; and
a dialkylamine-based dispersant, wherein
the dialkylamine-based dispersant is represented by the following compositional formula (1):

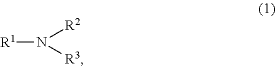

where,
R¹ is a hydrocarbon group, and
R² and R³ are each independently an alkyl group having 1 or more and 3 or less carbon atoms.

According to the 1st aspect, it is possible to obtain a solid electrolyte composition suitable for suppressing a decrease in the ion conductivity when a member of a battery, such as a solid electrolyte sheet, is produced. In addition, it is possible to obtain a solid electrolyte composition with improved fluidity and dispersion stability.

In a 2nd aspect of the present disclosure, for example, in the solid electrolyte composition according to the 1st aspect, the R¹ may be an alkyl group having 8 or more and 22 or less carbon atoms or an alkenyl group having 8 or more and 22 or less carbon atoms.

According to the 2nd aspect, the dispersion stability of the solid electrolyte composition can be more improved.

In a 3rd aspect of the present disclosure, for example, in the solid electrolyte composition according to the 1st or 2nd aspect, the 1% weight loss temperature of the dialkylamine-based dispersant may be lower than 225° C.

According to the 3rd aspect, since the dialkylamine-based dispersant easily evaporates by being heated, a decrease in the ion conductivity when a solid electrolyte sheet is produced can be more suppressed.

In a 4th aspect of the present disclosure, for example, in the solid electrolyte composition according to any one of the 1st to 3rd aspects, the solid electrolyte composition may further include a solvent, and the solid electrolyte may be dispersed in the solvent.

According to the 4th aspect, the dispersion stability of the solid electrolyte composition can be more improved.

In a 5th aspect of the present disclosure, for example, in the solid electrolyte composition according to any one of the 1st to 4th aspects, the solid electrolyte composition may further include a binder, and the binder may include a styrenic elastomer.

According to the 5th aspect, the styrenic elastomer has excellent flexibility and elasticity and is therefore suitable as a binder of a solid electrolyte sheet.

In a 6th aspect of the present disclosure, for example, in the solid electrolyte composition according to the 5th aspect, the styrenic elastomer may include modified styrene-butadiene rubber.

According to the 6th aspect, the modified styrene-butadiene rubber (SBR) can more disperse solid electrolyte particles.

In a 7th aspect of the present disclosure, for example, in the solid electrolyte composition according to any one of the 1st to 6th aspects, the solid electrolyte may have a particle shape, and the dialkylamine-based dispersant may be positioned between a plurality of particles of the solid electrolyte.

According to the 7th aspect, the dispersion stability of the solid electrolyte composition can be more improved.

In an 8th aspect of the present disclosure, for example, in the solid electrolyte composition according to any one of the 1st to 7th aspects, the solid electrolyte composition may be slurry.

According to the 8th aspect, a solid electrolyte composition with good fluidity can be obtained.

An electrode composition according to a 9th aspect of the present disclosure includes:
the solid electrolyte composition according to any one of the 1st to 8th aspects; and
an active material.

According to the 9th aspect, it is possible to obtain an electrode composition suitable for suppressing a decrease in the ion conductivity. In addition, it is possible to obtain an electrode composition with improved fluidity and dispersion stability.

A solid electrolyte sheet according to a 10th aspect of the present disclosure includes;
a solid electrolyte; and
a dialkylamine-based dispersant, wherein
the dialkylamine-based dispersant is represented by the following compositional formula (1):

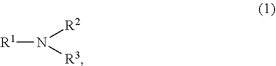

where,
R¹ is a hydrocarbon group, and
R² and R³ are each independently an alkyl group having 1 or more and 3 or less carbon atoms.

According to the 10th aspect, a solid electrolyte sheet with suppressed decrease in the ion conductivity can be obtained.

An electrode sheet according to an 11th aspect of the present disclosure includes:
an active material;
a solid electrolyte; and
a dialkylamine-based dispersant, wherein
the dialkylamine-based dispersant is represented by the following compositional formula (1):

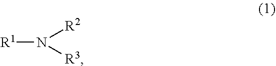

where,
R¹ is a hydrocarbon group, and
R² and R³ are each independently an alkyl group having 1 or more and 3 or less carbon atoms.

According to the 11th aspect, an electrode sheet with suppressed decrease in the ion conductivity can be obtained.

A battery according to a 12th aspect of the present disclosure includes:
a positive electrode;
a negative electrode; and
an electrolyte layer disposed between the positive electrode and the negative electrode, wherein
at least one selected from the group consisting of the positive electrode, the negative electrode, and the electrolyte layer includes a dialkylamine-based dispersant, and
the dialkylamine-based dispersant is represented by the following compositional formula (1):

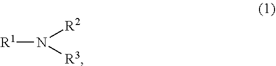

where,
R¹ is a hydrocarbon group, and
R² and R³ are each independently an alkyl group having 1 or more and 3 or less carbon atoms.

According to the 12th aspect, a battery with suppressed decrease in the ion conductivity is obtained.

A method for manufacturing a solid electrolyte composition according to a 13th aspect of the present disclosure includes:
mixing a solid electrolyte and a dialkylamine-based dispersant, wherein
the dialkylamine-based dispersant is represented by the following compositional formula (1):

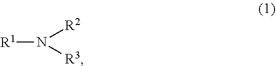

where,
R¹ is a hydrocarbon group, and
R² and R³ are each independently an alkyl group having 1 or more and 3 or less carbon atoms.

According to the 13th aspect, it is possible to manufacture a solid electrolyte composition suitable for suppressing a decrease in the ion conductivity when a member of a battery, such as a solid electrolyte sheet, is produced.

Embodiments of the present disclosure will now be described with reference to the drawings, but the present disclosure is not limited to the following embodiments.

### Embodiment 1

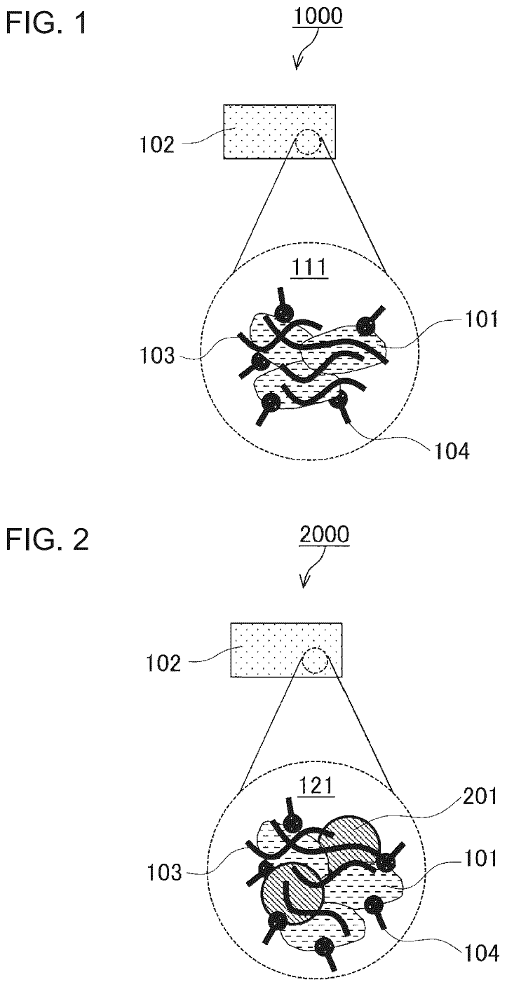

FIG. 1 is a schematic view of a solid electrolyte composition 1000 according to embodiment 1. The solid electrolyte composition 1000 includes a solid electrolyte 101 and a dialkylamine-based dispersant 104. The solid electrolyte composition 1000 may include a binder 103 and a solvent 102. The solid electrolyte composition 1000 includes, for example, an ion conductor 111 and a solvent 102. The ion conductor 111 includes the solid electrolyte 101, the binder 103, and the dialkylamine-based dispersant 104. The ion conductor 111 is dispersed or dissolved in the solvent 102. That is, the solid electrolyte 101, the binder 103, and the dialkylamine-based dispersant 104 are dispersed or dissolved in the solvent 102. The dialkylamine-based dispersant 104 is represented by the following compositional formula (1):

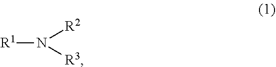

where, R¹ is a hydrocarbon group, and R² and R³ are each independently an alkyl group having 1 or more and 3 or less carbon atoms.

By the above constitution, a solid electrolyte composition 1000 suitable for suppressing a decrease in the ion conductivity when a member of a battery, such as a solid electrolyte sheet, is produced is obtained. The solid electrolyte composition 1000 can suppress a decrease in the lithium ion conductivity, for example, when a solid electrolyte sheet is produced. In addition, it is possible to obtain a solid electrolyte composition 1000 with improved fluidity and dispersion stability.

In manufacturing of the solid electrolyte composition 1000, an appropriate amount of the dialkylamine-based dispersant 104 is added to the solid electrolyte 101. On this occasion, desired interaction occurs between the solid electrolyte 101 and the dialkylamine-based dispersant 104. The dialkylamine-based dispersant 104 has a portion represented by the formula (2) shown below. It is believed that the desired interaction is caused between this portion and the solid electrolyte 101, and thereby a decrease in the ion conductivity is suppressed. In addition, the dialkylamine-based dispersant 104 has a hydrocarbon group R¹. Consequently, in the solid electrolyte composition, the dialkylamine-based dispersant 104 can improve the dispersibility of the solid electrolyte 101. As a result, a solid electrolyte composition 1000 with excellent dispersion stability is obtained. In the formula (2), the wavy line indicates a binding site.

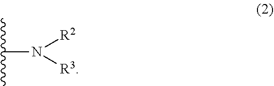

The solid electrolyte composition 1000 may be slurry having fluidity. A solid electrolyte composition 1000 having fluidity can form a solid electrolyte sheet by a wet method such as a coating method.

The “solid electrolyte sheet” may be a self-supporting sheet member or may be a solid electrolyte layer being supported by an electrode or a base material.

The solid electrolyte composition 1000 will be described in detail below.

### Solid Electrolyte Composition

The solid electrolyte composition 1000 includes, for example, an ion conductor 111 and a solvent 102. The ion conductor 111 includes a solid electrolyte 101, a binder 103, and a dialkylamine-based dispersant 104. The ion conductor 111 is dispersed in the solvent 102. The solid electrolyte 101 and the binder 103 are dispersed in the solvent 102. The solid electrolyte 101, the binder 103, the dialkylamine-based dispersant 104, the ion conductor 111, and the solvent 102 will be described in detail below.

### Solid Electrolyte

In embodiment 1, as the solid electrolyte 101, a sulfide solid electrolyte, an oxide solid electrolyte, a halide solid electrolyte, a polymeric solid electrolyte, a complex hydride solid electrolyte, or the like can be used. The solid electrolyte 101 may include a sulfide solid electrolyte. The solid electrolyte 101 may be a sulfide solid electrolyte. The sulfide solid electrolyte may include lithium. If a sulfide solid electrolyte including lithium is used as the solid electrolyte 101, a lithium secondary battery can be manufactured using a solid electrolyte sheet that is obtained from the solid electrolyte composition 1000 containing this sulfide solid electrolyte.

In the present disclosure, the term “oxide solid electrolyte” means a solid electrolyte containing oxygen. The oxide solid electrolyte may further contain an anion other than sulfur and halogen elements, as an anion other than oxygen.

In the present disclosure, the term “halide solid electrolyte” means a solid electrolyte containing a halogen element and not containing sulfur. In the present disclosure, a solid electrolyte not containing sulfur means a solid electrolyte represented by a compositional formula not including a sulfur element. Accordingly, a solid electrolyte containing a trace amount of a sulfur component, for example, 0.1 mass % or less of sulfur, is included in the solid electrolyte not containing sulfur. The halide solid electrolyte may further contain oxygen as an anion other than the halogen element.

As the sulfide solid electrolyte, for example, Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂ can be used. LiX, Li₂O, MO_{q}, LiₚMO_{q}, or the like may be added to these electrolytes. Element X in “LiX” is at least one selected from the group consisting of F, Cl, Br, and I. Element M in “MO_{q}” and “LiₚMO_{q}” is at least one selected from the group consisting of P, Si, Ge, B, Al, Ga, In, Fe, and Zn. p and q in “MO_{q}” and “LiₚMO_{q}” are each independently a natural number.

As the sulfide solid electrolyte, for example, Li₂S—P₂S₅-based glass ceramic may be used. To the Li₂S—P₂S₅-based glass ceramic, LiX, Li₂O, MO_{q}, LiₚMO_{q}, or the like may be added, or two or more selected from LiCl, LiBr, and LiI may be added. Since Li₂S—P₂S₅-based glass ceramic is a relatively soft material, a battery having higher durability can be manufactured by a solid electrolyte sheet including Li₂S—P₂S₅-based glass ceramic.

As the oxide solid electrolyte, it is possible to use, for example, glass or glass ceramic in which Li₂SO₄, Li₂CO₃, or the like is added to a base such as an NASICON-type solid electrolyte represented by LiTi₂(PO₄)₃ and an element substitute thereof, a (LaLi)TiO₃-based perovskite-type solid electrolyte, an LISICON-type solid electrolyte represented by Li₁₄ZnGe₄O₁₆, Li₄SiO₄, and LiGeO₄ and an element substitute thereof, a garnet-type solid electrolyte represented by Li₇La₃Zr₂O₁₂ and an element substitute thereof, Li₃PO₄ and an N-substitute thereof, and an Li—B—O compound such as LiBO₂ and Li₃BO₃.

The halide solid electrolyte includes, for example, Li, M1, and X. M1 is at least one selected from the group consisting of metal elements other than Li and metalloid elements. X is at least one selected from the group consisting of F, Cl, Br, and I. The halide solid electrolyte has high thermal stability and therefore can improve the safety of a battery. Furthermore, the halide solid electrolyte is sulfur-free and therefore can suppress generation of hydrogen sulfide gas.

In the present disclosure, the “metalloid elements” are B, Si, Ge, As, Sb, and Te.

In the present disclosure, the “metal elements” are all elements, excluding hydrogen, included in Groups 1 to 12 of the periodic table and all elements, excluding B, Si, Ge, As, Sb, Te, C, N, P, O, S, and Se, included in Groups 13 to 16 of the periodic table.

That is, in the present disclosure, the “metalloid elements” and the “metal elements” are element groups that can become cations when forming inorganic compounds with halogen elements.

For example, the halide solid electrolyte may be a material represented by the following compositional formula (1):

LiₐM1_{β}X_{γ} formula (1).

In the compositional formula (1), α, β, and γ are each independently a value larger than 0, and γ may be, for example, 4 or 6.

According to the above constitution, the ion conductivity of the halide solid electrolyte is improved, and therefore it is possible to improve the ion conductivity of a solid electrolyte sheet formed from the solid electrolyte composition 1000 according to embodiment 1. When this solid electrolyte sheet is used in a battery, the cycle characteristics of the battery can be more improved.

In the compositional formula (1), element M1 may include Y (yttrium). That is, the halide solid electrolyte may include Y as a metal element.

The halide solid electrolyte including Y may be represented by, for example, the following compositional formula (2):

LiₐMe_{b}Y_{c}X₆ formula (2).

In the formula (2), a, b, and c may satisfy a+mb+3c=6 and c>0. Element Me is at least one selected from the group consisting of metal elements other than Li and Y and metalloid elements, and m represents the valence of element Me. When element Me includes multiple types of elements, mb is the sum of the products of the composition ratio of each element and the valence of the element. For example, when Me includes element Me1 and element Me2, and the composition ratio of element Me1 is b1, the valence of element Me1 is m1, the composition ratio of element Me2 is b2, and the valence of element Me2 is m2, mb is represented by m1b1+m2b2. In the compositional formula (2), element X is at least one selected from the group consisting of F, Cl, Br, and I.

Element Me may be, for example, at least one selected from the group consisting of Mg, Ca, Sr, Ba, Zn, Sc, Al, Ga, Bi, Zr, Hf, Ti, Sn, Ta, Gd, and Nb.

As the halide solid electrolyte, for example. materials below can be used. The ion conductivity of the solid electrolyte 101 is more improved by the materials below, and thereby the ion conductivity of a solid electrolyte sheet formed from the solid electrolyte composition 1000 can be improved. The cycle characteristics of the battery can be more improved by this solid electrolyte sheet.

The halide solid electrolyte may be a material represented by the following compositional formula (A1):

Li_{6-3d}Y_{d}X₆ formula (A1).

In the compositional formula (A1), element X is at least one selected from the group consisting of Cl, Br, and I. In the compositional formula (A1), d satisfies 0<d<2.

The halide solid electrolyte may be a material represented by the following compositional formula (A2):

Li₃YX₆ formula (A2).

In the compositional formula (A2), element X is at least one selected from the group consisting of Cl, Br, and I.

The halide solid electrolyte may be a material represented by the following compositional formula (A3):

Li_{3-3δ}Y_{1+δ}Cl₆ formula (A3).

In the compositional formula (A3), δ satisfies 0<δ≤0.15.

The halide solid electrolyte may be a material represented by the following compositional formula (A4):

Li_{3-3δ}Y_{1+δ}Br₆ formula (A4).

In the compositional formula (A4), δ satisfies 0<δ≤0.25.

The halide solid electrolyte may be a material represented by the following compositional formula (A5):

Li_{3-3δ+a}Y_{1+δ-a}MeₐCl_{6-x-y}BrₓI_{y} formula (A5).

In the compositional formula (A5), element Me is at least one selected from the group consisting of Mg, Ca, Sr, Ba, and Zn.

Furthermore, in the compositional formula (A5),

$$- 1 < δ < 2 , \\ 0 < a < 3 , \\ 0 < ( 3 - 3 δ + a ) , \\ 0 < ( 1 + δ - a ) , \\ 0 \leq x \leq 6 , \\ 0 \leq y \leq 6 , and \\ ( x + y ) \leq 6 are satisfied .$$

The halide solid electrolyte may be a material represented by the following compositional formula (A6):

Li_{3-3δ}Y_{1+δ-a}MeₐCl_{6-x-y}BrₓI_{y} formula (A6).

In the compositional formula (A6), element Me is at least one selected from the group consisting of Al, Sc, Ga, and Bi.

Furthermore, in the above compositional formula (A6),

$$- 1 < δ < 1 , \\ 0 < a < 2 , \\ 0 < ( 1 + δ - a ) , \\ 0 \leq x \leq 6 , \\ 0 \leq y \leq 6 , and$$

$$( x + y ) \leq 6 are satisfied .$$

The halide solid electrolyte may be a material represented by the following compositional formula (A7):

Li_{3-3δ-a}Y_{1+δ-a}MeₐCl_{6-x-y}BrₓI_{y} formula (A7).

In the compositional formula (A7), element Me is at least one selected from the group consisting of Zr, Hf, and Ti.

Furthermore, in the above compositional formula (A7),

$$- 1 < δ < 1 , \\ 0 < a < 1.5 , \\ 0 < ( 3 - 3 δ - a ) , \\ 0 < ( 1 + δ - a ) , \\ 0 \leq x \leq 6 , \\ 0 \leq y \leq 6 , and \\ ( x + y ) \leq 6 are satisfied .$$

The halide solid electrolyte may be a material represented by the following compositional formula (A8):

Li_{3-3δ-2a}Y_{1+δ-a}MeₐCl_{6-x-y}BrₓI_{y} formula (A8).

In the compositional formula (A8), element Me is at least one selected from the group consisting of Ta and Nb.

Furthermore, in the above compositional formula (A8),

$$- 1 < δ < 1 , \\ 0 < a < 1.2 , \\ 0 < ( 3 - 3 δ - 2 a ) , \\ 0 < ( 1 + δ - a ) , \\ 0 \leq x \leq 6 , \\ 0 \leq y \leq 6 , and \\ ( x + y ) \leq 6 are satisfied .$$

The halide solid electrolyte may be a compound including Li, M2, O (oxygen), and X2. Element M2 includes, for example, at least one selected from the group consisting of Nb and Ta. X2 is at least one selected from the group consisting of F, Cl, Br, and I.

The compound including Li, M2, X2, and O (oxygen) may be represented by, for example, a compositional formula: LiₓM2O_{y}X2_{5+x-2y}. where, x may satisfy 0.1<x<7.0, and y may satisfy 0.4<y<1.9.

As the halide solid electrolyte, more specifically, for example, Li₃Y (Cl,Br,I)₆, Li_{2.7}Y_{1.1}(Cl,Br,I)₆, Li₂Mg(F,Cl,Br,I)₄, Li₂Fe(F,Cl,Br,I)₄, Li(Al,Ga,In)(F,Cl,Br,I)₄, Li₃(Al,Ga,In)(F,Cl,Br,I)₆, Li₃(Ca,Y,Gd)(Cl,Br,I)₆, Li_{2.7}(Ti,Al)F₆, Li_{2.5}(Ti,Al)F₆, and Li(Ta,Nb)O(F,Cl)₄ can be used. In the present disclosure, when the elements in a formula are represented by such as “(Al,Ga,In)”, this notation indicates at least one element selected from the element group in the parentheses. That is, “(Al,Ga,In)” is synonymous with “at least one selected from the group consisting of Al, Ga, and In”. The same applies to other elements.

As the polymeric solid electrolyte, for example, a compound of a polymer compound and a lithium salt can be used. The polymer compound may have an ethylene oxide structure. A polymer compound having an ethylene oxide structure can contain a large amount of a lithium salt. Accordingly, it can more improve ion conductivity. As the lithium salt, LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), LiC(SO₂CF₃)₃, and so on can be used. The lithium salts may be used alone or in combination of two or more thereof.

As the complex hydride solid electrolyte, for example, LiBH₄—LiI and LiBH₄—P₂S₅ can be used.

The shape of the solid electrolyte 101 is not particularly limited, and may be, for example, needle, spherical, or oval spherical. The solid electrolyte 101 may have a particulate shape.

When the shape of the solid electrolyte 101 is particulate (e.g., spherical), the median diameter of the solid electrolyte 101 may be 1 μm or more and 100 μm or less or 1 μm or more and 10 μm or less. When the solid electrolyte 101 has a median diameter of 1 μm or more and 100 μm or less, the solid electrolyte 101 can be easily dispersed in the solvent 102.

When the shape of the solid electrolyte 101 is particulate (e.g., spherical), the median diameter of the solid electrolyte 101 may be 0.1 μm or more and 5 μm or less or 0.5 μm or more and 3 μm or less. When the solid electrolyte 101 has a median diameter of 0.1 μm or more and 5 μm or less, a solid electrolyte sheet manufactured from the solid electrolyte composition 1000 can have a higher surface smoothness and can have a denser structure.

The median diameter means a particle diameter at which the cumulative volume in a volume-based particle size distribution is equal to 50%. The volume-based particle size distribution can be determined by a laser diffraction and scattering method. The same applies to the other materials described below.

The specific surface area of the solid electrolyte 101 may be 0.1 m²/g or more and 100 m²/g or less or 1 m²/g or more and 10 m²/g or less. When the solid electrolyte 101 has a specific surface area of 0.1 m²/g or more and 100 m²/g or less, the solid electrolyte 101 can be easily dispersed in the solvent 102. The specific surface area can be measured by a BET multipoint method using a gas adsorption measurement device.

The ion conductivity of the solid electrolyte 101 may be 0.01 mS/cm² or more, 0.1 mS/cm² or more, or 1 mS/cm² or more. When the solid electrolyte 101 has an ion conductivity of 0.01 mS/cm² or more, the output characteristics of the battery can be improved.

### Binder

The binder 103 can improve the dispersion stability of the solid electrolyte 101 in the solvent 102 in the solid electrolyte composition 1000. The binder 103 can improve the adhesiveness between individual particles of the solid electrolyte 101 in the solid electrolyte sheet.

The binder 103 may include a styrenic elastomer. The styrenic elastomer is an elastomer including a repeating unit derived from styrene. The repeating unit is a molecular structure derived from a monomer and is sometimes called a constituting unit. Styrenic elastomers are excellent in flexibility and elasticity and are therefore suitable as the binder 103 of the solid electrolyte sheet. In the styrenic elastomer, the content percentage of the repeating unit derived from styrene is not particularly limited and is, for example, 10 mass % or more and 70 mass % or less.

The styrenic elastomer may be a block copolymer including a first block constituted of a repeating unit derived from styrene and a second block constituted of a repeating unit derived from conjugated diene. Examples of the conjugated diene include butadiene and isoprene. The repeating unit derived from conjugated diene may be hydrogenated. That is, the repeating unit derived from conjugated diene may or may not have an unsaturated bond such as a carbon-carbon double bond. The block copolymer may have a triblock sequence constituted of two first blocks and one second block. The block copolymer may be an ABA type triblock copolymer. In this triblock copolymer, the A block corresponds to the first block, and the B block corresponds to the second block. The first block functions as, for example, a hard segment. The second block functions as, for example, a soft segment.

Examples of the styrenic elastomer include a styrene-ethylene/butylene-styrene block copolymer (SEBS), a styrene-ethylene/propylene-styrene block copolymer (SEPS), a styrene-ethylene/ethylene/propylene-styrene block copolymer (SEEPS), styrene-butadiene rubber (SBR), a styrene-butadiene-styrene block copolymer (SBS), a styrene-isoprene-styrene block copolymer (SIS), and hydrogenated styrene-butadiene rubber (HSBR). The binder 103 may include SBR or SEBS as the styrenic elastomer. As the binder 103, a mixture of two or more selected from these styrenic elastomers may be used. The styrenic elastomer may include SBR. Since styrenic elastomers are excellent in flexibility and elasticity, according to the binder 103 including the styrenic elastomer, the dispersion stability and fluidity of the solid electrolyte composition 1000 can be improved. Furthermore, the surface smoothness of a solid electrolyte sheet manufactured from the solid electrolyte composition 1000 can be improved. In addition, according to the binder including a styrenic elastomer, flexibility can be imparted to the solid electrolyte sheet. As a result, a decrease in the thickness of the electrolyte layer of a battery using the solid electrolyte sheet can be realized, and the energy density of the battery can be improved.

The styrenic elastomer may be a styrenic triblock copolymer. Examples of the styrenic triblock copolymer include a styrene-ethylene/butylene-styrene block copolymer (SEBS), a styrene-ethylene/propylene-styrene block copolymer (SEPS), a styrene-ethylene/ethylene/propylene-styrene block copolymer (SEEPS), a styrene-butadiene-styrene block copolymer (SBS), and a styrene-isoprene-styrene block copolymer (SIS). These styrenic triblock copolymers are sometimes called styrenic thermoplastic elastomers. These styrenic triblock copolymers tend to be flexible and have high strength.

The styrenic elastomer may include styrene-butadiene rubber (SBR). The styrenic elastomer may be SBR. The SBR has excellent flexibility and elasticity and also exhibits excellent filling properties during thermal compression and is therefore particularly suitable as the binder of the solid electrolyte sheet.

The styrenic elastomer may include a modifying group. The modifying group is a functional group that chemically modifies all repeating units included in a polymer chain, a part of the repeating units included in a polymer chain, or a terminal of a polymer chain. The modifying group can be introduced into a polymer chain by a substitution reaction, an addition reaction, or the like. The modifying group includes, for example, an element having a relatively high electronegativity, such as O, N, S, F, Cl, Br, and F, or having a relatively low electronegativity, such as Si, Sn, and P. A modifying group including such an element can impart polarity to the polymer. Examples of the modifying group include a carboxylate group, an acid anhydride group, an acyl group, a hydroxy group, a sulfo group, a sulfanyl group, a phosphate group, a phosphonate group, an isocyanate group, an epoxy group, a silyl group, an amino group, a nitrile group, and a nitro group. An example of the acid anhydride group is a maleic anhydride group. The modifying group may be a functional group that can be introduced by being reacted with a modifier of a compound below. Examples of the modifier compound include an epoxy compound, an ether compound, an ester compound, an isocyanate compound, an isothiocyanate compound, an isocyanuric acid derivative, a nitrogen group-containing carbonyl compound, a nitrogen group-containing vinyl compound, a nitrogen group-containing epoxy compound, a mercapto group derivative, a thiocarbonyl compound, an isothiocyanate compound, a halogenated silicon compound, an epoxidized silicon compound, a vinylated silicon compound, an alkoxy silicon compound, a nitrogen group-containing alkoxy silicon compound, a halogenated tin compound, an organic tin carboxylate compound, a phosphite compound, and a phosphino compound. In the binder 103, when the styrenic elastomer includes the above-mentioned modifying group, the dispersibility of the solid electrolyte 101 included in the solid electrolyte composition 1000 can be more improved. In addition, the peel strength of the solid electrolyte sheet and the electrode sheet can be improved by the interaction with a current collector.

The styrenic elastomer may include a modifying group having a nitrogen atom. The modifying group having a nitrogen atom is a nitrogen-containing functional group, and examples thereof include an amino group such as an amine compound. The position of the modifying group may be the polymer chain terminal. A styrenic elastomer having a modifying group at the polymer chain terminal can have an effect similar to that of so-called surfactant. That is, when a styrenic elastomer having a modifying group at the polymer chain terminal is used, the modifying group adsorbs to the solid electrolyte 101, and the polymer chain can suppress aggregation of individual particles of the solid electrolyte 101. As a result, the dispersibility of the solid electrolyte 101 can be more improved. The styrenic elastomer may be, for example, a terminal amine-modified styrenic elastomer. The styrenic elastomer may be, for example, a styrenic elastomer having a nitrogen atom at at least one terminal of the polymer chain and having a star-shaped polymer structure with a nitrogen-containing alkoxysilane substituent at the center.

The styrenic elastomer may include at least one selected from the group consisting of modified SBR and modified SEBS. The modified SBR means SRB having an introduced modifying group. The modified SEBS means SEBR having an introduced modifying group. The modified SBR and the modified SEBS can more disperse solid electrolyte particles and therefore are particularly suitable as the binder of the solid electrolyte sheet. The styrenic elastomer may include modified SBR.

The weight average molecular weight (Mw) of the styrenic elastomer may be 200,000 or more. The styrenic elastomer may have a weight average molecular weight of 300,000 or more, 500,000 or more, 800,000 or more, or 1,000,000 or more. The upper limit of the weight average molecular weight is, for example, 1,500,000. When the styrenic elastomer has a weight average molecular weight of 200,000 or more, individual particles of the solid electrolyte 101 can be bonded to each other with sufficient adhesive strength. When the styrenic elastomer has a weight average molecular weight of 1,500,000 or less, the ionic conduction between individual particles of the solid electrolyte 101 is hardly inhibited by the binder 103, and the output characteristics of the battery can be improved. The weight average molecular weight of the styrenic elastomer can be specified by, for example, gel permeation chromatography (GPC) measurement using polystyrene as a reference standard. In other words, the weight average molecular weight is a value converted from polystyrene. In GPC measurement, chloroform may be used as the eluent. When two or more peak tops are observed in a chart obtained by GPC measurement, the weight average molecular weight calculated from the whole peak range including each peak top can be regarded as the weight average molecular weight of the styrenic elastomer.

In the styrenic elastomer, the ratio of the polymerization degree of the repeating unit derived from styrene and the polymerization degree of the repeating unit derived from other than styrene is defined as m:n. On this occasion, in the styrenic elastomer, the molar fraction (φ) of the repeating unit derived from styrene can be calculated by φ=m/(m+n). In the styrenic elastomer, the molar fraction (φ) of the repeating unit derived from styrene can be determined by, for example, proton nuclear magnetic resonance (¹H NMR) measurement.

In the styrenic elastomer, the molar fraction (φ) of the repeating unit derived from styrene may be 0.05 or more and 0.55 or less or 0.1 or more and 0.3 or less. A styrenic elastomer having a φ of 0.05 or more can improve the strength of the solid electrolyte sheet. A styrenic elastomer having a φ of 0.55 or less can improve the flexibility of the solid electrolyte sheet.

The binder 103 may include a binder other than the styrenic elastomer, such as the binding agent that is generally used as the binder for a battery. Alternatively, the binder 103 may be a styrenic elastomer. In other words, the binder 103 may include a styrenic elastomer only.

Examples of the binding agent include polyvinylidene fluoride (PVDF), polytetrafluoroethylene (PTFE), polyethylene, polypropylene, aramide resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester (PMMA), polymethacrylic acid ethyl ester, polymethacrylic acid hexyl ester, polyvinyl acetate, polyvinylpyrrolidone, polyether, polycarbonate, polyethersulfone, polyetherketone, polyetheretherketone, polyphenylene sulfide, hexafluoropolypropylene, styrene-butadiene rubber, carboxymethyl cellulose, and ethyl cellulose. As the binding agent, a copolymer synthesized using two or more monomers selected from the group consisting of tetrafluoroethylene, hexafluoroethylene, hexafluoropropylene, perfluoroalkylvinyl ether, fluorinated vinylidene, chlorotrifluoroethylene, ethylene, propylene, butadiene, isoprene, styrene, pentafluoropropylene, fluoromethylvinyl ether, acrylic acid ester, acrylic acid, and hexadiene can also be used. These binding agents may be used alone or in combination of two or more thereof.

The binding agent may include an elastomer from the viewpoint of excellent binding properties. The elastomer is a polymer having rubber elasticity. The elastomer that is used as the binding agent may be a thermoplastic elastomer or may be a thermosetting elastomer. Examples of the elastomer include, in addition to the above-described styrenic elastomers, butadiene rubber (BR), isoprene rubber (IR), chloroprene rubber (CR), acrylonitrile-butadiene rubber (NBR), hydrogenated isoprene rubber (HIR), hydrogenated butyl rubber (HIIR), hydrogenated nitrile rubber (HNBR), and acrylate butadiene rubber (ABR). A mixture including two or more selected from these elastomers may be used.

### Dialkylamine-Based Dispersant

The dialkylamine-based dispersant 104 can improve the wettability and dispersibility of the solid electrolyte 101 to the solvent 102.

The dialkylamine-based dispersant 104 is represented by the following compositional formula (1):

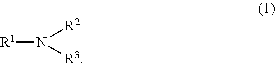

In compositional formula (1), R¹ is a hydrocarbon group. R² and R³ are each independently an alkyl group having 1 or more and 3 or less carbon atoms.

According to the above constitution, it is possible to obtain a solid electrolyte composition suitable for suppressing a decrease in the ion conductivity. In addition, according to the above constitution, a solid electrolyte composition 1000 with improved fluidity and dispersion stability can be obtained.

In the dialkylamine-based dispersant 104, R¹ may be an alkyl group having 8 or more and 22 or less carbon atoms or an alkenyl group having 8 or more and 22 or less carbon atoms. When the number of carbon atoms of the alkyl group or alkenyl group is 8 or more, the dispersibility of the solid electrolyte 101 can be improved. When the number of carbon atoms of the alkyl group or alkenyl group is 22 or less, a decrease in the ion conductivity when a solid electrolyte sheet is produced can be more suppressed.

In the dialkylamine-based dispersant 104, the alkyl group may be a straight-chain alkyl group. The straight-chain alkyl group is a substituent consisting of an aliphatic saturated hydrocarbon in which atoms other than hydrogen atoms, i.e., carbon atoms, are linked together without branching.

In the dialkylamine-based dispersant 104, the alkenyl group may be a straight-chain alkenyl group. The straight-chain alkenyl group is a substituent constituted of an aliphatic unsaturated hydrocarbon in which atoms other than hydrogen atoms, i.e., carbon atoms, are linked together without branching. The position of the unsaturated bond in the alkenyl group is not particularly limited. The number of the unsaturated bond in the alkenyl group is not particularly limited and may be one or two or more.

In the dialkylamine-based dispersant 104, the number of carbon atoms of the alkyl group or alkenyl group may be 8 or more and 20 or less or 8 or more and 18 or less.

In the compositional formula (1), R² and R³ are each independently an alkyl group having 1 or more and 3 or less carbon atoms. R² and R³ can reduce the nucleophilicity and basicity of the dialkylamine-based dispersant 104. Consequently, the reaction between the dialkylamine-based dispersant 104 and the solid electrolyte 101 can be suppressed, or excessive adsorption between the dialkylamine-based dispersant 104 and the solid electrolyte 101 can be suppressed. Consequently, the solid electrolyte 101 is hardly deteriorated. As a result, a decrease in the ion conductivity when a solid electrolyte sheet is produced can be more suppressed.

In the compositional formula (1), R² and R³ may be alkyl groups having the same composition. Examples of the alkyl group having 1 or more and 3 or less carbon atoms are a methyl group, an ethyl group, a propyl group, and an isopropyl group. R² and R³ are methyl groups. Consequently, the steric hindrance of the alkyl group bonding to a nitrogen atom is reduced, and thereby the dispersibility of the solid electrolyte 101 can be improved.

The dialkylamine-based dispersant 104 may include a dimethylamine-based dispersant. Examples of the dimethylamine-based dispersant include dimethylbutylamine, dimethyloctylamine, and dimethylpalmitylamine.

The dialkylamine-based dispersant 104 may not include a hydroxy group (—OH). The hydroxy group can excessively react with the solid electrolyte, and the solid electrolyte easily deteriorates. When the dialkylamine-based dispersant 104 does not include a hydroxy group, the solid electrolyte hardly deteriorates. As a result, a decrease in the ion conductivity when a solid electrolyte sheet is produced can be more suppressed.

In the solid electrolyte composition 1000, the 1% weight loss temperature of the dialkylamine-based dispersant may be lower than 225° C. That is, when the weight of the dialkylamine-based dispersant 104 is measured by simultaneous thermogravimetry-differential thermal analysis (TG-DTA), the temperature at which the weight of the dialkylamine-based dispersant 104 decreased by 1% from the weight before measurement may be lower than 225° C. Consequently, since the dialkylamine-based dispersant 104 easily evaporates by being heated, a decrease in the ion conductivity of a solid electrolyte sheet manufactured from the solid electrolyte composition 1000 can be more suppressed. The temperature at which the weight of the dialkylamine-based dispersant 104 decreased by 1% from the weight before measurement may be 10° C. or more and 200° C. or less or 30° C. or more and 150° C. or less. The temperature at which the weight of the dialkylamine-based dispersant 104 decreased by 1% from the weight before measurement can be measured by, for example, simultaneous thermogravimetry-differential thermal analysis (TG-DTA) through the method described later.

### Ion Conductor

As described above, the ion conductor 111 includes a solid electrolyte 101, a binder 103, and a dialkylamine-based dispersant 104. In the ion conductor 111, multiple particles of the solid electrolyte 101 are bound to each other via the binder 103. In the ion conductor 111, the particles of the solid electrolyte 101 are dispersed by the dialkylamine-based dispersant 104 adsorbed to the solid electrolyte 101. The dialkylamine-based dispersant 104 is placed between multiple particles of the solid electrolyte 101.

In the ion conductor 111, the mass proportion of the binder 103 to the solid electrolyte 101 is not particularly limited, and may be 0.1 mass % or more and 10 mass % or less, 0.5 mass % or more and 5 mass % or less, or 1 mass % or more and 3 mass % or less. When the mass proportion of the binder 103 to the solid electrolyte 101 is 0.1 mass % or more, it is possible to improve the strength of a solid electrolyte sheet manufactured from the solid electrolyte composition 1000. When the mass proportion of the binder 103 to the solid electrolyte 101 is 10 mass % or less, it is possible to suppress a decrease in the ion conductivity of the ion conductor 111.

The ion conductor 111 can be produced by, for example, mixing a solid electrolyte 101, a binder 103, and a dialkylamine-based dispersant 104. The method for mixing these materials is not particularly limited, and examples thereof include a dry method of mechanically pulverizing and mixing the solid electrolyte 101, the binder 103, and the dialkylamine-based dispersant 104. A wet method of preparing a solution or dispersion including the binder 103 and a solution or dispersion including the dialkylamine-based dispersant 104, dispersing the solid electrolyte 101 therein, and mixing them may be used. According to the wet method, the binder 103, the dialkylamine-based dispersant 104, and the solid electrolyte 101 can be mixed simply and uniformly. The solid electrolyte composition 1000 may be produced by producing the ion conductor 111 in a solvent by a wet method.

### Solvent

The solvent 102 may be an organic solvent. The organic solvent is a compound including carbon and is, for example, a compound including elements such as carbon, hydrogen, nitrogen, oxygen, sulfur, and a halogen.

The solvent 102 may include at least one selected from the group consisting of hydrocarbons, compounds having halogen groups, and compounds having ether bonds.

The hydrocarbon is a compound consisting of carbon and hydrogen only. The hydrocarbon may be an aliphatic hydrocarbon. The hydrocarbon may be a saturated hydrocarbon or an unsaturated hydrocarbon. The hydrocarbon may be a straight chain or a branched chain. The number of carbon atoms included in the hydrocarbon is not particularly limited and may be 7 or more. A solid electrolyte composition 1000 with improved dispersibility of the ion conductor 111 can be obtained by using hydrocarbon. Furthermore, it is possible to suppress a decrease in the ion conductivity of the solid electrolyte 101 due to mixing with the solvent 102.

The hydrocarbon may have a ring structure. The ring structure may be an alicyclic hydrocarbon or an aromatic hydrocarbon. The ring structure may be monocyclic or polycyclic. When the hydrocarbon has a ring structure, the ion conductor 111 can be easily dispersed in the solvent 102. From the viewpoint of enhancing the dispersibility of the ion conductor 111 in the solid electrolyte composition 1000, the hydrocarbon may include an aromatic hydrocarbon. That is, the solvent 102 may include an aromatic hydrocarbon. The hydrocarbon may be an aromatic hydrocarbon. A styrenic elastomer has high solubility in an aromatic hydrocarbon. Accordingly, when the binder 103 includes a styrenic elastomer and further the solvent 102 includes an aromatic hydrocarbon, it is possible to more efficiently adsorb the binder 103 to the solid electrolyte 101 in the solid electrolyte composition 1000. Consequently, the performance of the solid electrolyte composition 1000 of retaining the solvent can be more improved.

In the compound having a halogen group, the portion other than the halogen group may be composed only of carbon and hydrogen. That is, the compound having a halogen group is a compound in which at least one of hydrogen atoms included in hydrocarbon is substituted with a halogen group. Examples of the halogen group include F, Cl, Br, and I. As the halogen group, at least one selected from the group consisting of F, Cl, Br, and I may be used. The compound having a halogen group can have high polarity. The ion conductor 111 can be easily dispersed in the solvent 102 by using the compound having a halogen group as the solvent 102. Accordingly, a solid electrolyte composition 1000 with excellent dispersibility can be obtained. As a result, a solid electrolyte sheet manufactured from the solid electrolyte composition 1000 can have an excellent ion conductivity and can have a denser structure.

The number of carbon atoms included in the compound having a halogen group is not particularly limited and may be 7 or more. Consequently, since the compound having a halogen group is unlikely to volatilize, a solid electrolyte composition with improved fluidity can be obtained. In addition, the solid electrolyte composition 1000 can be manufactured stably by using the compound having a halogen group. The compound having a halogen group can have a large molecular weight. That is, the compound having a halogen group can have a high boiling point.

The compound having a halogen group may have a ring structure. The ring structure may be an alicyclic hydrocarbon or an aromatic hydrocarbon. The ring structure may be monocyclic or polycyclic. When the compound having a halogen group has a ring structure, the ion conductor 111 can be easily dispersed in the solvent 102. From the viewpoint of improving the dispersibility of the ion conductor 111 in the solid electrolyte composition 1000, the compound having a halogen group may include an aromatic hydrocarbon. The compound having a halogen group may be an aromatic hydrocarbon.

The compound having a halogen group may have a halogen group only as the functional group. In this case, the number of the halogen included in the compound having a halogen group is not particularly limited. As the halogen group, at least one selected from the group consisting of F, Cl, Br, and I may be used. Since the ion conductor 111 can be easily dispersed in the solvent 102 by using the above-mentioned compound as the solvent 102, a solid electrolyte composition 1000 with excellent dispersibility can be obtained. As a result, a solid electrolyte sheet manufactured from the solid electrolyte composition 1000 can have excellent ion conductivity and can have a denser structure. By using such a compound as the solvent 102, the solid electrolyte sheet manufactured from the solid electrolyte composition 1000 can easily have a dense structure with few pinholes, irregularities, and so on.

The compound having a halogen group may be a halogenated hydrocarbon. The halogenated hydrocarbon is a compound in which all hydrogen atoms included in the hydrocarbon are substituted with halogen groups. Since the ion conductor 111 can be easily dispersed in the solvent 102 by using a halogenated hydrocarbon as the solvent 102, a solid electrolyte composition 1000 with excellent dispersibility can be obtained. As a result, the solid electrolyte sheet manufactured from the solid electrolyte composition 1000 can have an excellent ion conductivity and have a denser structure. By using such a compound as the solvent 102, the solid electrolyte sheet manufactured from the solid electrolyte composition 1000 can easily have, for example, a dense structure with few pinholes, irregularities, and so on.

In the compound having an ether bond, the portion other than the ether bond may be composed only of carbon and hydrogen. That is, the compound having an ether bond is a compound in which at least one of C—C bonds included in a hydrocarbon is substituted with a C—O—C bond. The compound having an ether bond can have high polarity. The ion conductor 111 can be easily dispersed in the solvent 102 by using the compound having an ether bond as the solvent 102. Accordingly, a solid electrolyte composition 1000 with excellent dispersibility can be obtained. As a result, the solid electrolyte sheet manufactured from the solid electrolyte composition 1000 can have an excellent ion conductivity and can have a denser structure.

The compound having an ether bond may have a ring structure. The ring structure may be an alicyclic hydrocarbon or an aromatic hydrocarbon. The ring structure may be monocyclic or polycyclic. When the compound having an ether bond has a ring structure, the ion conductor 111 can be easily dispersed in the solvent 102. From the viewpoint of improving the dispersibility of the ion conductor 111 in the solid electrolyte composition 1000, the compound having an ether bond may include an aromatic hydrocarbon. The compound having an ether bond may be an aromatic hydrocarbon substituted with an ether group.

Examples of the solvent 102 include ethylbenzene, mesitylene, pseudocumene, p-xylene, cumene, tetralin, m-xylene, dibutyl ether, 1,2,4-trichlorobenzene, chlorobenzene, 2,4-dichlorotoluene, anisole, o-chlorotoluene, m-dichlorobenzene, p-chlorotoluene, o-dichlorobenzene, 1,4-dichlorobutane, and 3,4-dichlorotoluene. These solvents may be used alone or in combination of two or more thereof.

From the viewpoint of cost, as the solvent 102, a commercially available xylene, i.e., mixed xylene, may be used. As the solvent 102, for example, mixed xylene in which o-xylene, m-xylene, p-xylene, and ethylbenzene are mixed in a mass ratio of 24:42:18:16 may be used.

The solvent 102 may include tetralin. Tetralin has a relatively high boiling point. According to tetralin, not only the performance of the solid electrolyte composition 1000 of retaining the solvent can be improved, but also the solid electrolyte composition 1000 can be stably manufactured by a kneading process.

The boiling point of the solvent 102 may be 100° C. or more and 250° C. or less, 130° C. or more and 230° C. or less, 150° C. or more and 220° C. or less, or 180° C. or more and 210° C. or less. The solvent 102 may be a liquid at ordinary temperature (25° C.). Since such a solvent is unlikely to volatilize at ordinary temperature, the solid electrolyte composition 1000 can be manufactured stably. Accordingly, a solid electrolyte composition 1000 that can be easily applied to the surface of an electrode or base material is obtained. The solvent 102 included in the solid electrolyte composition 1000 can be easily removed by drying described later.

The water content of the solvent 102 may be 10 mass ppm or less. A decrease in the ion conductivity due to reaction of the solid electrolyte 101 can be suppressed by decreasing the water content. Examples of the method for decreasing the water content include a dehydration method using a molecular sieve and a dehydration method by bubbling using an inert gas such as nitrogen gas and argon gas. According to the dehydration method by bubbling using inert gas, a decrease in the water content and deoxidization are possible. The water content can be measured with a Karl Fischer moisture analyzer.

The solvent 102 disperses the ion conductor 111. The solvent 102 can be a liquid in which the solid electrolyte 101 can be dispersed. The solid electrolyte 101 may not be dissolved in the solvent 102. When the solid electrolyte 101 is not dissolved in the solvent 102, the ionic conduction phase during the manufacturing of the solid electrolyte 101 is easily maintained. Accordingly, in a solid electrolyte sheet manufactured using this solid electrolyte composition 1000, a decrease in the ion conductivity can be suppressed.

The solvent 102 may dissolve a part or the whole of the solid electrolyte 101. The denseness of the solid electrolyte sheet manufactured using the solid electrolyte composition 1000 can be improved by the solid electrolyte 101 being dissolved in the solvent 102.

### Solid Electrolyte Composition

As described above, the solid electrolyte composition 1000 may be slurry having fluidity. The slurry is a fluid that contains solid particles in a liquid. The slurry may be a suspension of solid particles dispersed in a liquid. The ion conductor 111 is, for example, particles. In the solid electrolyte composition 1000, the particles of the ion conductor 111 are mixed with the solvent 102. In manufacturing of the solid electrolyte composition 1000, the method for mixing the ion conductor 111 and the solvent 102 or the method for mixing the solid electrolyte 101, the solvent 102, the binder 103, and the dialkylamine-based dispersant 104 is not particularly limited. Examples of the mixing method include those using mixing devices such as stirring, shaking, ultrasonic, and rotary type devices. Examples of the mixing method include those using dispersing and kneading equipment such as a high-speed homogenizer, a thin-film swirling high-speed mixer, an ultrasonic homogenizer, a high-pressure homogenizer, a ball mill, a bead mill, a planetary mixer, a sand mill, a roll mill, and a kneader. These mixing methods may be used alone or in combination of two or more thereof.

As the method for mixing the solid electrolyte 101, the solvent 102, the binder 103, and the dialkylamine-based dispersant 104, high-shear treatment using a high-speed homogenizer or high-shear treatment using an ultrasonic homogenizer may be adopted. According to these high-shear treatment, the dialkylamine-based dispersant 104 can be efficiently adsorbed to the surfaces of the particles of the solid electrolyte 101. As a result, it is possible to more improve the dispersion stability of the solid electrolyte composition 1000 manufactured by these high-shear treatment.

### Manufacturing Method of Solid Electrolyte Composition

The manufacturing method of the solid electrolyte composition 1000 includes mixing of a solid electrolyte 101 and a dialkylamine-based dispersant 104.

The solid electrolyte composition 1000 is manufactured by, for example, the following method. First, a solid electrolyte 101 and a solvent 102 are mixed, and a binder solution, a solution containing a dialkylamine-based dispersant 104, and so on are further added thereto. The resulting mixture solution is subjected to high-speed shear treatment using an in-line type dispersion and pulverization device. In such a process, an ion conductor 111 is formed, the ion conductor 111 is dispersed and stabilized in the solvent 102, and a solid electrolyte composition 1000 with more excellent fluidity can be manufactured. The solid electrolyte composition 1000 may be produced by mixing the solvent 102 and the ion conductor 111 produced in advance and subjecting the resulting mixture solution to high-speed shear treatment.

The solid electrolyte composition 1000 may be manufactured by the following method. First, a solid electrolyte 101 and a solvent 102 are mixed, and a solution containing a binder 103, a dialkylamine-based dispersant 104, and so on are further added thereto. The resulting mixture solution is subjected to high-shear treatment using an ultrasonic homogenizer. In such a process, an ion conductor 111 is formed, the ion conductor 111 is dispersed and stabilized in the solvent 102, and a solid electrolyte composition 1000 with more excellent fluidity can be manufactured. The solid electrolyte composition 1000 may be produced by mixing the solvent 102 and the ion conductor 111 produced in advance and subjecting the resulting mixture solution to ultrasonic high-shear treatment.

From the viewpoint of manufacturing a solid electrolyte composition 1000 with more improved fluidity, high-speed shear treatment or ultrasonic high-shear treatment may be performed under conditions of not causing pulverization of the particles of the solid electrolyte 101 but causing disintegration of individual particles of the solid electrolyte 101.

The solution containing the binder 103 is, for example, a solution including the binder 103 and the solvent 102. The composition of the solvent included in the solution containing the binder 103 may be the same as or different from the composition of the solvent included in the dispersion of the solid electrolyte 101.

The solution containing the dialkylamine-based dispersant 104 is, for example, a solution including the dialkylamine-based dispersant 104 and the solvent 102. The composition of the solvent included in the solution containing the nitrogen-containing organic substance 104 may be the same as or different from the composition of the solvent included in the dispersion of the solid electrolyte 101.

The solid content concentration of the solid electrolyte composition 1000 is appropriately determined according to the particle diameter of the solid electrolyte 101, the specific surface area of the solid electrolyte 101, the type of the solvent 102, the type of the binder 103, and the type of the dialkylamine-based dispersant 104. The solid content concentration may be 20 mass % or more and 70 mass % or less or 30 mass % or more and 60 mass % or less. Since the solid electrolyte composition 1000 has a desired viscosity by adjusting the solid content concentration to 20 mass % or more, the solid electrolyte composition 1000 can be easily applied to a substrate such as an electrode. When the solid electrolyte composition 1000 is applied to a substrate, the thickness of the wet film can be relatively increased by adjusting the solid content concentration to 70 mass % or less. Consequently, a solid electrolyte sheet with a more uniform thickness can be manufactured.

### Embodiment 2

Embodiment 2 will now be described. Descriptions that overlap with those of embodiment 1 will be omitted as appropriate.

The electrode composition 2000 may be slurry having fluidity. An electrode composition 2000 having fluidity can form an electrode sheet by a wet method such as a coating method. The “electrode sheet” may be a self-supporting sheet member or may be a positive electrode layer or negative electrode layer being supported by a current collector, a base material, or an electrode assembly.

FIG. 2 is a schematic view of an electrode composition 2000 according to embodiment 2. The electrode composition 2000 includes an ion conductor 121 and a solvent 102. The ion conductor 121 includes a solid electrolyte 101, a binder 103, a dialkylamine-based dispersant 104, and an active material 201. The ion conductor 121 is dispersed or dissolved in the solvent 102. That is, the solid electrolyte 101, the binder 103, the dialkylamine-based dispersant 104, and the active material 201 are dispersed or dissolved in the solvent 102. In other words, the electrode composition 2000 includes an active material 201 and a solid electrolyte composition 1000. The solid electrolyte composition 1000 includes the solid electrolyte 101, the solvent 102, the binder 103, and the dialkylamine-based dispersant 104. The solid electrolyte composition 1000 is as described in embodiment 1 above. The electrode composition 2000 is the solid electrolyte composition 1000 to which the active material 201 is added. The characteristics and effects of the electrode composition 2000 are the same as those of the solid electrolyte composition 1000. In the following, the active material 201 will be described in detail.

### Active Material

The active material 201 according to embodiment 2 includes a material that has a property of occluding and releasing metal ions (e.g., lithium ions). The active material 201 includes, for example, a positive electrode active material or a negative electrode active material. When the electrode composition 2000 includes the active material 201, a lithium secondary battery can be manufactured by using an electrode sheet obtained from the electrode composition 2000.

The active material 201 includes a positive electrode active material, for example, includes a material that has a property of occluding and releasing metal ions (e.g., lithium ions), as the positive electrode active material. Examples of the positive electrode active material include a lithium-containing transition metal oxide, a transition metal fluoride, a polyanion material, a fluorinated polyanion material, a transition metal sulfide, a transition metal oxysulfide, and a transition metal oxynitride. Examples of the lithium-containing transition metal oxide include Li(NiCoAl)O₂, Li(NiCoMn)O₂, and LiCoO₂. For example, when a lithium-containing transition metal oxide is used as the positive electrode active material, the manufacturing cost of the electrode composition 2000 can be decreased, and the average discharging voltage of a battery can be improved. Li(NiCoAl)O₂ means that Ni, Co, and Al are included at an arbitrary ratio. Li(NiCoMn)O₂ means that Ni, Co, and Mn are included at an arbitrary ratio.

The median diameter of the positive electrode active material may be 0.1 μm or more and 100 μm or less or 1 μm or more and 10 μm or less. When the positive electrode active material has a median diameter of 0.1 μm or more, in the electrode composition 2000, the active material 201 can be easily dispersed in the solvent 102. As a result, the charge and discharge characteristics of the battery using an electrode sheet manufactured from the electrode composition 2000 are improved. When the positive electrode active material has a median diameter of 100 μm or less, the lithium diffusion speed in the positive electrode active material is improved. Accordingly, the battery can operate at high output.

The active material 201 includes a negative electrode active material, for example, includes a material that has a property of occluding and releasing metal ions (e.g., lithium ions), as the negative electrode active material. Examples of the negative electrode active material include a metal material, a carbon material, an oxide, a nitride, a tin compound, and a silicon compound. The metal material may be a single metal or an alloy. Examples of the metal material include a lithium metal and a lithium alloy. Examples of the carbon material include natural graphite, coke, graphitizing carbon, carbon fibers, spherical carbon, artificial graphite, and amorphous carbon. The capacity density of a battery can be improved by using silicon (Si), tin (Sn), a silicon compound, a tin compound, or the like. The safety of a battery can be improved by using an oxide compound including titanium (Ti) or niobium (Nb).

The median diameter of the negative electrode active material may be 0.1 μm or more and 100 μm or less or 1 μm or more and 10 μm or less. When the negative electrode active material has a median diameter of 0.1 μm or more, in the electrode composition 2000, the active material 201 can be easily dispersed in the solvent 102. As a result, the charge and discharge characteristics of the battery using an electrode sheet manufactured from the electrode composition 2000 are improved. When the negative electrode active material has a median diameter of 100 μm or less, the lithium diffusion speed in the negative electrode active material is improved. Accordingly, the battery can operate at high output.

The positive electrode active material and the negative electrode active material may be covered with a covering material in order to decrease the interface resistance between each of the active materials and the solid electrolyte. That is, a covering layer may be provided on the surfaces of the positive electrode active material and the negative electrode active material. The covering layer is a layer including a covering material. As the covering material, a material having low electron conductivity can be used. As the covering material, an oxide material, an oxide solid electrolyte, a halide solid electrolyte, a sulfide solid electrolyte, and so on can be used. The positive electrode active material and the negative electrode active material may be covered with only one covering material selected from the above-mentioned materials. That is, as the covering layer, a covering layer formed of only one covering material selected from the above-mentioned materials may be provided. Alternatively, two or more covering layers formed using two or more covering materials selected from the above-mentioned materials may be provided.

Examples of the oxide material that is used as the covering material include SiO₂, Al₂O₃, TiO₂, B₂O₃, Nb₂O₅, WO₃, and ZrO₂.

As the oxide solid electrolyte that is used as the covering material, the oxide solid electrolytes exemplified in embodiment 1 may be used, and examples thereof include Li—Nb—O compounds such as LiNbO₃, Li—B—O compounds such as LiBO₂ and Li₃BO₃, Li—Al—O compounds such as LiAlO₂, Li—Si—O compounds such as Li₄SiO₄, Li—Ti—O compounds such as Li₂TiO₄ and Li₄Ti₅O₁₂, Li—Zr—O compounds such as Li₂ZrO₃, Li—Mo—O compounds such as Li₂MoO₃, Li—V—O compounds such as LiV₂0₅, Li—W—O compounds such as Li₂WO₄, and Li—P—O compounds such as LiPO₄. The oxide solid electrolytes have high potential stability. Accordingly, the cycle performance of the battery can be more improved by using the oxide solid electrolyte as the covering material.

As the halide solid electrolyte that is used as the covering material, the halide solid electrolytes exemplified in embodiment 1 may be used, and examples thereof include Li—Y—Cl compounds such as LiYCl₆, Li—Y—Br—Cl compounds such as LiYBr₂Cl₄, Li—Ta—O—Cl compounds such as LiTaOCl₄, and Li—Ti—Al—F compounds such as Li_{2.7}Ti_{0.3}Al_{0.7}F₆. The halide solid electrolytes have high ion conductivities and high high-potential stability. Accordingly, the cycle performance of the battery can be more improved by using a halide solid electrolyte as the covering material.

As the sulfide solid electrolyte that is used as the covering material, sulfide solid electrolytes exemplified in embodiment 1 may be used, and examples thereof include Li—P—S compounds such as Li₂S—P₂S₅. The sulfide solid electrolytes have high ion conductivities and low Young's moduluses. Accordingly, uniform cover can be realized by using the sulfide solid electrolyte as the covering material, and the cycle performance of the battery can be more improved.

### Electrode Composition

The electrode composition 2000 may be in a paste state or in a dispersion state. The active material 201 and the ion conductor 111 are, for example, particles. In manufacturing of the electrode composition 2000, the particles of the active material 201 and the particles of the ion conductor 111 are mixed with the solvent 102. In manufacturing of the electrode composition 2000, the method for mixing the active material 201, the ion conductor 111, and the solvent 102, i.e., the method for mixing the active material 201, the solid electrolyte 101, the solvent 102, the binder 103, and the dialkylamine-based dispersant 104, is not particularly limited. Examples of the mixing method include those using mixing devices such as stirring, shaking, ultrasonic, and rotary type devices. Examples of the mixing method include those using dispersing and kneading equipment such as a high-speed homogenizer, a thin-film swirling high-speed mixer, an ultrasonic homogenizer, a high-pressure homogenizer, a ball mill, a bead mill, a planetary mixer, a sand mill, a roll mill, and a kneader. These mixing methods may be used alone or in combination of two or more thereof.

### Manufacturing Method of Electrode Composition

The manufacturing method of the electrode composition 2000 includes mixing an active material 201, a solid electrolyte 101, and a dialkylamine-based dispersant 104.

The electrode composition 2000 is manufactured by, for example, the following method. First, an active material 201 and a solvent 102 are mixed to prepare a dispersion. A solution containing a binder 103 and a solution containing a dialkylamine-based dispersant 104 are added to the resulting dispersion. The resulting mixture solution is subjected to high-speed shear treatment using an in-line type dispersion and pulverization device. A solid electrolyte 101 is added to the resulting dispersion. The resulting mixture solution is subjected to high-speed shear treatment using an in-line type dispersion and pulverization device. In such a process, an ion conductor 111 is formed, the active material 201 and the ion conductor 111 are dispersed and stabilized in the solvent 102, and an electrode composition 2000 with more excellent fluidity can be manufactured. The electrode composition 2000 may be produced by mixing a solvent 10, an ion conductor 111 produced in advance, and an active material 201 and subjecting the resulting mixture solution to high-speed shear treatment. The electrode composition 2000 may be produced by mixing the solid electrolyte composition 1000 produced in advance and the active material 201 and subjecting the resulting mixture solution to high-speed shear treatment.

The electrode composition 2000 may be manufactured by, for example, the following method. An active material 201 and a solvent 102 are mixed, and a solution containing a binder 103 and a solution containing a dialkylamine-based dispersant 104 are further added thereto. The resulting mixture solution is subjected to high-shear treatment using an ultrasonic homogenizer. A solid electrolyte 101 is added to the resulting dispersion. The resulting mixture solution is subjected to high-shear treatment using an ultrasonic homogenizer. In such a process, an ion conductor 111 is formed, the active material 201 and the ion conductor 111 are dispersed and stabilized in the solvent 102, and an electrode composition 2000 with more excellent fluidity can be manufactured. The electrode composition 2000 may be produced by mixing the solvent 102, the ion conductor 111 prepared in advance, and the active material 201, and subjecting the resulting mixture solution to ultrasonic high-shear treatment. The electrode composition 2000 may be produced by mixing the solid electrolyte composition 1000 produced in advance and the active material 201 and subjecting the resulting mixture solution to ultrasonic high-shear treatment.

From the viewpoint of manufacturing the electrode composition 2000 with improved fluidity, high-speed shear treatment or ultrasonic high-shear treatment may be performed under conditions of not causing pulverization of the particles of the solid electrolyte 101 and the particles of the active material 201 but causing disintegration of individual particles of the solid electrolyte 101 and individual particles of the active material 201.

The electrode composition 2000 may include a conductive assistant for the purpose of improving the electron conductivity. Examples of the conductive assistant include graphite such as natural graphite and artificial graphite, carbon black such as acetylene black and Ketjen black, conductive fibers such as carbon fibers and metal fibers, conductive powder such as carbon fluoride and aluminum, conductive whiskers such as zinc oxide and potassium titanate, conductive metal oxides such as titanium oxide, and conductive polymeric compounds such as polyaniline, polypyrrole, and polythiophene. It is possible to reduce the cost by using a carbon material as the conductive assistant.

In the electrode composition 2000, the mass proportion of the ion conductor 111 to the active material 201 is not particularly limited, and may be, for example, 10 mass % or more and 150 mass % or less and may be, for example, 20 mass % or more and 100 mass % or less or 30 mass % or more and 70 mass % or less. When the mass proportion of the ion conductor 111 is 10 mass % or more, in the electrode composition 2000, the ion conductivity can be improved, and an increase in the output of the battery can be realized. When the mass proportion of the ion conductor 111 is 150 mass % or less, an increase in the energy density of the battery can be realized.

The solid content concentration of the electrode composition 2000 is appropriately determined according to the particle diameter of the active material 201, the specific surface area of the active material 201, the particle diameter of the solid electrolyte 101, the specific surface area of the solid electrolyte 101, the type of the solvent 102, the type of the binder 103, and the type of the dialkylamine-based dispersant 104. The solid content concentration of the electrode composition 2000 may be 40 mass % or more and 90 mass % or less or 50 mass % or more and 80 mass % or less. Since the electrode composition 2000 has a desired viscosity by adjusting the solid content concentration to 40 mass % or more, the electrode composition 2000 can be easily applied to a substrate such as an electrode. When the electrode composition 2000 is applied to a substrate, the thickness of the wet film can be relatively increased by adjusting the solid content concentration to 90 mass % or less. Consequently, an electrode sheet with a more uniform thickness can be manufactured.

### Embodiment 3

Embodiment 3 will now be described. Descriptions that overlap with those of embodiment 1 or 2 will be omitted as appropriate.

The solid electrolyte sheet according to embodiment 3 is manufactured using the solid electrolyte composition 1000. A manufacturing method of the solid electrolyte sheet includes applying the solid electrolyte composition 1000 to an electrode or a base material to form a coating film and removing the solvent from the coating film.

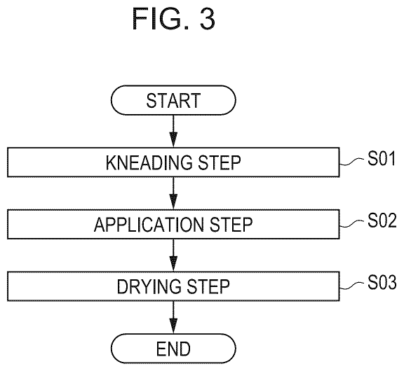

The method for manufacturing a solid electrolyte sheet will now be described with reference to FIG. 3. FIG. 3 is a flow chart showing a method for manufacturing a solid electrolyte sheet.

The method for manufacturing a solid electrolyte sheet may include a step S01, a step S02, and a step S03. The step S01 in FIG. 3 corresponds to the manufacturing method of the solid electrolyte composition 1000 described in embodiment 1. The method for manufacturing a solid electrolyte sheet includes the step S02 of applying the solid electrolyte composition 1000 in embodiment 1 and the step S03 of drying it. The step S01, the step S02, and the step S03 may be implemented in this order. A solid electrolyte sheet that can suppress a decrease in the ion conductivity can be manufactured by the above steps using the solid electrolyte composition 1000. In this manner, the solid electrolyte sheet is obtained by applying and drying the solid electrolyte composition 1000. In other words, the solid electrolyte sheet is a solidified matter of the solid electrolyte composition 1000. The solid electrolyte sheet includes the solid electrolyte 101 and the dialkylamine-based dispersant 104.

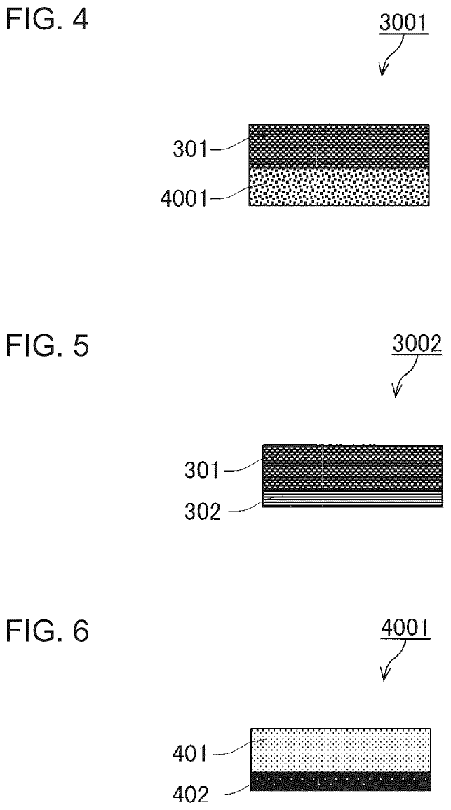

FIG. 4 is a cross-sectional view of an electrode assembly 3001 according to embodiment 3. The electrode assembly 3001 includes an electrode 4001 and a solid electrolyte sheet 301 disposed on the electrode 4001. The electrode assembly 3001 can be manufactured by including a step of applying the solid electrolyte composition 1000 to the electrode 4001 as the step S02.

FIG. 5 is a cross-sectional view of a transfer sheet 3002 according to embodiment 3. The transfer sheet 3002 includes a base material 302 and a solid electrolyte sheet 301 disposed on the base material 302. The transfer sheet 3002 can be manufactured by including a step of applying the solid electrolyte composition 1000 to the base material 302 as the step S02.

In the step S02, the solid electrolyte composition 1000 is applied to the electrode 4001 or the base material 302. Consequently, a coating film of the solid electrolyte composition 1000 is formed on the electrode 4001 or the base material 302.

The electrode 4001 is a positive electrode or a negative electrode. The positive electrode or the negative electrode includes a current collector and an active material layer disposed on the current collector. An electrode assembly 3001 consisting of a layered product of the electrode 4001 and the solid electrolyte sheet 301 is manufactured by applying the solid electrolyte composition 1000 to the electrode 4001 and subjecting it to the step S03 described later.

Examples of the material that is used as the base material 302 include metal foil and a resin film. Examples of the material of the metal foil include copper (Cu), aluminum (Al), iron (Fe), nickel (Ni), and alloys thereof. Examples of the material of the resin film include polyethylene terephthalate (PET), polyimide (PI), and polytetrafluoroethylene (PTFE). A transfer sheet 3002 consisting of a layered product of the base material 302 and the solid electrolyte sheet 301 is manufactured by applying the solid electrolyte composition 1000 to the base material 302 and subjecting it to the step S03 described later.

Examples of the application method include a die coating method, a gravure coating method, a doctor blade method, a bar coating method, a spray coating method, and an electrostatic coating method. From the viewpoint of mass productivity, the application may be performed by a die coating method.

In the step S03, the solid electrolyte composition 1000 applied to the electrode 4001 or the base material 302 is dried. For example, the solvent 102 is removed from the coating film of the solid electrolyte composition 1000 by drying the solid electrolyte composition 1000 to manufacture a solid electrolyte sheet 301.

Examples of the drying method for removing the solvent 102 from the solid electrolyte composition 1000 include warm air/hot air drying, infrared heating drying, reduced pressure drying, vacuum drying, high frequency dielectric heating drying, and high frequency induction heating drying. These methods may be used alone or in combination of two or more thereof.

The solvent 102 may be removed from the solid electrolyte composition 1000 by reduced pressure drying. That is, the solvent 102 may be removed from the solid electrolyte composition 1000 in a pressure atmosphere lower than the atmospheric pressure. The pressure atmosphere lower than the atmospheric pressure may be, for example, −0.01 MPa or less as gauge pressure. The reduced pressure drying may be performed at 50° C. or more and 250° C. or less.

The solvent 102 may be removed from the solid electrolyte composition 1000 by vacuum drying. That is, the solvent 102 may be removed from the solid electrolyte composition 1000 at a temperature lower than the boiling point of the solvent 102 and in an atmosphere less than or equal to the equilibrium vapor pressure of the solvent 102.

From the viewpoint of manufacturing cost, the solvent 102 may be removed from the solid electrolyte composition 1000 by warm air/hot air drying. The preset temperature of the warm air/hot air may be 50° C. or more and 250° C. or less or 80° C. or more and 150° C. or less.

In the step S03, a part or the whole of the dialkylamine-based dispersant 104 may be removed together with the removal of the solvent 102. The ion conductivity of the solid electrolyte sheet 301 and the strength of the coating film can be improved by removing the dialkylamine-based dispersant 104.

In the step S03, the dialkylamine-based dispersant 104 may not be removed together with the removal of the solvent 102. The dialkylamine-based dispersant 104 remaining in the solid electrolyte sheet 301 plays a role like a lubricant during pressure molding in the manufacturing of a battery. Consequently, the filling properties of the ion conductor 111 can be improved.

In the step S03, the amount of the solvent 102 and the amount of the dialkylamine-based dispersant 104 that are removed from the solid electrolyte composition 1000 can be adjusted by the drying method and drying conditions described above.

The removal of the solvent 102 and the dialkylamine-based dispersant 104 can be verified by, for example, Fourier transform infrared spectroscopy (FT-IR), X-ray photoelectron spectroscopy (XPS), gas chromatography (GC), or gas chromatography-mass spectrometry (GC/MS). As long as the solid electrolyte sheet 301 after drying has ion conductivity, the solvent 102 may not be completely removed. A part of the solvent 102 may remain in the solid electrolyte sheet 301.

The ion conductivity of the solid electrolyte sheet 301 may be 0.1 mS/cm or more or 1 mS/cm or more. The output characteristics of the battery can be improved by adjusting the ion conductivity to 0.1 mS/cm or more. For the purpose of improving the ion conductivity of the solid electrolyte sheet 301, the pressure molding may be performed using a pressing machine or the like.

### Embodiment 4

Embodiment 4 will now be described. Descriptions that overlap with those of any of embodiments 1 to 3 will be omitted as appropriate.

The electrode sheet according to embodiment 4 is manufactured using the electrode composition 2000. The manufacturing method of the electrode sheet according to embodiment 4 includes applying the electrode composition 2000 to a current collector, a base material, or an electrode assembly to form a coating film and removing the solvent from the coating film.

The manufacturing method of the electrode sheet is the same as the manufacturing method of the solid electrolyte sheet 301 described in embodiment 3 except that the base in manufacturing of the solid electrolyte sheet 301 described in embodiment 3 above is partially different. Accordingly, the manufacturing method of the electrode sheet will be also described with reference to FIG. 3. That is, FIG. 3 corresponds also to the flow chart showing the manufacturing method of the electrode sheet.

The manufacturing method of the electrode sheet may include a step S01, a step S02, and a step S03. The step S01 in FIG. 3 corresponds to the manufacturing method of the electrode composition 2000 described in embodiment 2. The manufacturing method of the electrode sheet includes the step S02 of applying the electrode composition 2000 according to embodiment 2 and the step S03 of drying it. The step S01, the step S02, and the step S03 may be implemented in this order. An electrode sheet that can suppress a decrease in the ion conductivity can be manufactured by the above steps using the electrode composition 2000. In this manner, the electrode sheet is obtained by applying and drying the electrode composition 2000. In other words, the electrode sheet is a solidified matter of the electrode composition 2000. The electrode sheet includes the active material 201, the solid electrolyte 101, and the dialkylamine-based dispersant 104.

FIG. 6 is a cross-sectional view of an electrode 4001 according to embodiment 4. The electrode 4001 includes a current collector 402 and an electrode sheet 401 disposed on the current collector 402. The electrode 4001 can be manufactured by including a step of applying the electrode composition 2000 to the current collector 402 as the step S02.

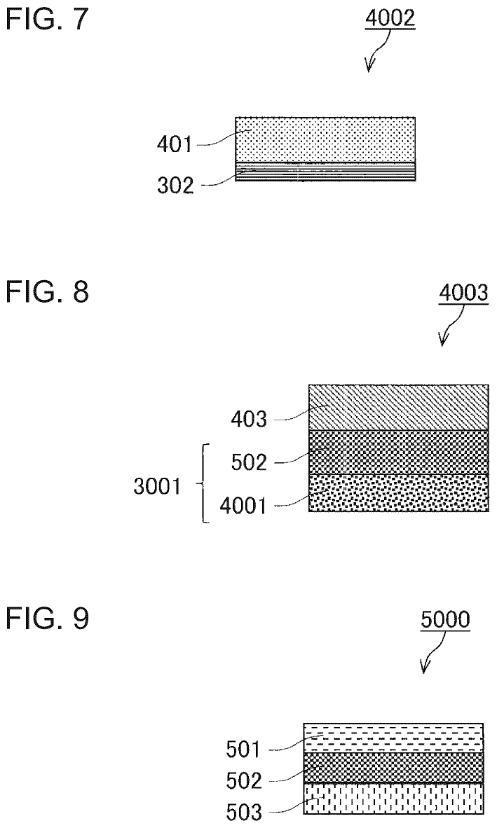

FIG. 7 is a cross-sectional view of an electrode transfer sheet 4002 according to embodiment 4. The electrode transfer sheet 4002 includes a base material 302 and an electrode sheet 401 disposed on the base material 302. As the material that is used as the base material 302, the materials exemplified in embodiment 3 can be used. The electrode transfer sheet 4002 consisting of a layered product of the base material 302 and the electrode sheet 401 can be manufactured by including a step of applying the electrode composition 2000 to the base material 302 as the step S02.

FIG. 8 is a cross-sectional view of a battery precursor 4003 according to embodiment 4. The battery precursor 4003 includes an electrode 4001, an electrolyte layer 502, and an electrode sheet 403. The electrolyte layer 502 is disposed on the electrode 4001. In addition, the electrode sheet 403 is disposed on the electrolyte layer 502. The electrode 4001 includes a current collector 402 and an electrode sheet 401 disposed on the current collector 402. The electrode assembly 3001 includes an electrode 4001 and an electrolyte layer 502 disposed on the electrode 4001. The electrolyte layer 502 includes a solid electrolyte sheet 301. A battery precursor 4003 can be manufactured by including a step of applying the electrode composition 2000 to the electrode assembly 3001 that is a layered product of the electrode 4001 and the electrolyte layer 502 as the step S02.

In the step S02, the electrode composition 2000 is applied to the current collector 402, the base material 302, or the electrode assembly 3001. Consequently, a coating film of the electrode composition 2000 is formed on the current collector 402, the base material 302, or the electrode assembly 3001.

Examples of the application method include a die coating method, a gravure coating method, a doctor blade method, a bar coating method, a spray coating method, and an electrostatic coating method. From the viewpoint of mass productivity, the application may be performed by a die coating method.

Examples of the material that is used as the current collector 402 include metal foil. Examples of the material of the metal foil include copper (Cu), aluminum (Al), iron (Fe), nickel (Ni), and alloys thereof. On the surface of such metal foil, a covering layer consisting of the above-described conductive assistant and the above-described binding agent may be provided. An electrode 4001 that is a layered product of the current collector 402 and the electrode sheet 401 is manufactured by applying the electrode composition 2000 onto the current collector 402 and subjecting it to the step S03 described later.

Subsequently, an electrolyte layer 502 is formed on the electrode 4001. The method for forming the electrolyte layer 502 is as described in embodiment 3. That is, the electrolyte layer 502 is formed on the electrode 4001 by applying the solid electrolyte composition 1000 to the electrode 4001 and subjecting it to the step S03. Consequently, an electrode assembly 3001 that is a layered product of the electrode 4001 and the electrolyte layer 502 is manufactured.

In the step S03, the applied solid electrolyte composition 1000 is dried. For example, the solvent 102 is removed from the coating film of the solid electrolyte composition 1000 by drying the solid electrolyte composition 1000 to manufacture an electrolyte layer 502.

Subsequently, an electrode sheet 403 is formed on the electrolyte layer 502. For example, the method for forming the electrode sheet 403 is the same as the method for forming the electrode sheet 401. That is, the electrode sheet 403 is formed on the electrolyte layer 502 by applying the electrode composition 2000 to the electrolyte layer 502 and subjecting it to the step S03.

In the step S03, the applied electrode composition 2000 is dried. For example, the solvent 102 is removed from the coating film of the electrode composition 2000 by drying the electrode composition 2000 to manufacture an electrode sheet 403.

The drying for removing the solvent 102 from the electrode composition 2000 is as described in embodiment 3 above.

The battery precursor 4003 can be manufactured by, for example, combining an electrode 4001 and an electrode sheet 403 having polarity opposite to that of the electrode 4001. That is, the active material included in the electrode sheet 401 is different from the active material included in the electrode sheet 403. In detail, when the active material included in the electrode sheet 401 is a positive electrode active material, the active material included in the electrode sheet 403 is a negative electrode active material. When the active material included in the electrode sheet 401 is a negative electrode active material, the active material included in the electrode sheet 403 is a positive electrode active material.

### Embodiment 5

Embodiment 5 will now be described. Descriptions that overlap with those of any of embodiments 1 to 4 will be omitted as appropriate.

FIG. 9 is a cross-sectional view of a battery 5000 according to embodiment 5.

The battery 5000 according to embodiment 5 includes a positive electrode 501, a negative electrode 503, and an electrolyte layer 502.

The electrolyte layer 502 is disposed between the positive electrode 501 and the negative electrode 503.

The electrolyte layer 502 may include the solid electrolyte sheet 301 according to embodiment 3, and any of the positive electrode 501 or the negative electrode 503 may include the electrode sheet 401 according to embodiment 4. That is, at least one selected from the group consisting of the positive electrode 501, the negative electrode 503, and the electrolyte layer 502 may include the dialkylamine-based dispersant 104. According to this constitution, a battery with suppressed decrease in the ion conductivity can be obtained.

The manufacturing method of the battery 5000 is not particularly limited. The battery 5000 may be manufactured by the following method. A negative electrode in which an electrode sheet (first negative electrode sheet) is laminated on a current collector, a first electrolyte layer, and a first positive electrode are disposed in this order. At the same time, on the surface of the current collector opposite to the surface on which the first negative electrode sheet is laminated, an electrode sheet (second negative electrode sheet), a second electrolyte layer, and a second positive electrode are disposed in this order. Consequently, a layered product of the first positive electrode, the first electrolyte layer, the first negative electrode sheet, the current collector, the second negative electrode sheet, the second electrolyte layer, and the second positive electrode disposed in this order is obtained. This layered product may be subjected to pressure molding using a pressing machine at ordinary temperature or high temperature to manufacture a battery 5000. According to such a method, it is possible to produce a layered product of two batteries 5000 while suppressing warping of the batteries, and a high-output battery 5000 can be manufactured more efficiently. In the production of the layered product, the order of laminating members is not particularly limited. For example, a layered product of two batteries 5000 may be produced by laminating a first negative electrode sheet and a second negative electrode sheet on a current collector and then disposing a first electrolyte layer, a second electrolyte layer, a first positive electrode, and a second positive electrode in this order.

Examples of the shape of the battery 5000 include a coin type, a cylinder type, a square type, a sheet type, a button type, a flat type, and a laminate type.

### EXAMPLES

Examples of the present disclosure will now be described. Examples below are merely examples, and the present disclosure is not limited to only the following Examples.

Each step was performed in a glove box or in a dry room. The dew point of the glove box and the dew point of the dry room were each adjusted t to −60° C. or less.

### Example 1

A solvent, a dispersant, and a binder were added to Li₂S—P₂S₅-based glass ceramic (hereinafter, referred to as “LPS”) in an argon glove box with a dew point of −60° C. or less. As the solvent, tetralin was used. As the binder, solution polymerized styrene-butadiene rubber (modified SBR, manufactured by Asahi Kasei Corporation, ASAPRENE Y031), which is a styrenic elastomer, was used. These materials were mixed in a mass ratio of solvent:LPS:binder:dispersant=100:100:0.25 to prepare a mixture solution. Subsequently, the resulting mixture solution was subjected to dispersing and kneading by shearing using a homogenizer (manufactured by AS ONE Corporation, HG-200) and a generator (manufactured by AS ONE Corporation, K-20S) to obtain a solid electrolyte composition according to Example 1. In Example 1, as the dispersant, dimethylbutylamine (manufactured by Tokyo Chemical Industry Co., Ltd., D1506) was used. Dimethylbutylamine has an alkyl group having 4 carbon atoms.

### Example 2

A solid electrolyte composition according to Example 2 was obtained by the same method as in Example 1 except that dimethyloctylamine (manufactured by Kao Corporation, D0898) was used as the dispersant. Dimethyloctylamine has an alkyl group having 8 carbon atoms.

### Example 3

A solid electrolyte composition according to Example 3 was obtained by the same method as in Example 1 except that dimethylpalmitylamine (manufactured by Kao Corporation, D0898) was used as the dispersant. Dimethylpalmitylamine has an alkyl group having 16 carbon atoms.

### Comparative Example 1

A solid electrolyte composition according to Comparative Example 1 was obtained by the same method as in Example 1 except that DISPERBYK 109 (hereinafter, referred to as “#109”) manufactured by BYK Japan KK was used as the dispersant. “DISPERBYK” is a registered trademark of BYK.

### Measurement of Relaxation Time

The relaxation time of each of the solid electrolyte compositions according to Examples and Comparative Example was measured. In the measurement of relaxation time, a pulse NMR measurement apparatus (MagnoMeter) manufactured by Mageleka Inc. was used. The results are shown in Table 1.

TABLE 1

| | Type of dispersant | Relaxation time (msec) |
|---|---|---|
| Example 1 | Dimethylbutylamine (D1506) | 899 |
| Example 2 | Dimethyloctylamine (DM0898) | 705 |
| Example 3 | Dimethylpalmitylamine (DM6098) | 447 |
| Comparative | #109 | 516 |
| Example 1 | | |

The relaxation time is an index representing the dispersibility of a solid electrolyte in a solid electrolyte composition. When the relaxation time is short, it can be determined that the dispersibility of a solid electrolyte in a solid electrolyte composition has been improved. As shown in Table 1, the relaxation time was decreased with an increase in the number of carbon atoms of the hydrocarbon group included in the dialkylamine-based dispersant. In particular, the relaxation time of the solid electrolyte composition according to Example 3 was shorter than that of the solid electrolyte composition according to Comparative Example 1. In the solid electrolyte composition, the dispersibility of the solid electrolyte was improved with an increase in the number of carbon atoms of the hydrocarbon group included in the dialkylamine-based dispersant.

### Evaluation of Rheology

The rheology of each of the solid electrolyte compositions of Examples and Comparative Example was evaluated in a dry room with a dew point of −40° C. or less. In the measurement, a viscosity/viscoelasticity measuring instrument (manufactured by Thermo Fisher Scientific Inc., HAAKE MARS40) and a cone plate with a diameter of 35 mm and an angle of 2° (manufactured by Thermo Fisher Scientific Inc., C35/2 Ti) were used. The strain of the solid electrolyte composition was measured at shear stress from 0.1 Pa to 200 Pa under conditions of 25° C. and the stress control mode (CS) to obtain a stress-strain curve (S-S curve). In the obtained S-S curve, the presence or absence of a yield point was verified. The results are shown in Table 2.

In addition, the viscosity of the solid electrolyte composition was measured when the shear rate was continuously increased from 0.001 sec⁻¹ to 1000 sec⁻¹ and then continuously decreased from 1000 sec⁻¹ to 0.1 sec⁻¹ to obtain a flow curve. The flow curve of the solid electrolyte composition in a shear rate from 0.1 sec⁻¹ to 1000 sec⁻¹ and the flow curve of the solid electrolyte composition in a shear rate from 1000 sec⁻¹ to 0.1 sec⁻¹ were compared to each other to verify the presence or absence of hysteresis. The results are shown in Table 2.

TABLE 2

| | Type of dispersant | S-S curve | Flow curve |
|---|---|---|---|
| Example 1 | Dimethylbutylamine | Yield point | Hysteresis is |
| | (D1506) | is present | present |
| Example 2 | Dimethyloctylamine | Yield point | Hysteresis is |
| | (DM0898) | is absent | absent |
| Example 3 | Dimethylpalmitylamine | Yield point | Hysteresis is |
| | (DM6098) | is absent | absent |
| Comparative | #109 | Yield point | Hysteresis is |
| Example 1 | | is absent | absent |

When a yield point is present, it can be determined that the slurry changed from an elastic one to a plastic one. When a yield point is absent, it can be determined that it is an elastic body. As shown in Table 2, in the solid electrolyte compositions according to Examples 2 and 3, no yield point was observed in the S-S curve.

When there is hysteresis, it can be determined that it is not stable as slurry. When there is not hysteresis, it can be determined that it is stable as slurry. As shown in Table 2, in the solid electrolyte compositions according to Examples 2 and 3, no hysteresis was observed in the flow curve. Accordingly, it was confirmed that the dispersibility was improved in the solid electrolyte compositions according to Examples 2 and 3.

### Example 4

A solid electrolyte composition according to Example 4 was obtained by the same method as in Example 1 except that dimethylbehenylamine (manufactured by Kao Corporation, DM2285) was used as the dispersant. Dimethylbehenylamine has an alkyl group having 22 carbon atoms.

### Comparative Example 2

A solid electrolyte composition according to Comparative Example 2 was obtained by the method as in Example 1 except that no dispersant was used. Measurement of ion conductivity

The ion conductivity of the ion conductor included in the solid electrolyte composition and the ion conductivity of the solid electrolyte included in the solid electrolyte composition were measured by the following method.

LPS was used as the solid electrolyte. LPS and a dispersant were mixed in an argon glove box with a dew point of −60° C. or less in a mass ratio of LPS:dispersant=100:1 to prepare an ion conductor. A solvent was added to the ion conductor to prepare a solid electrolyte composition. As the solvent, tetralin was used.

Subsequently, the solid electrolyte composition was dried. The drying of the solid electrolyte composition was performed by heating at 100° C. for 1 hour in a vacuum atmosphere. Consequently, the solvent was removed from the solid electrolyte composition to obtain a solid matter.

Subsequently, 100 mg of the ion conductor or 100 mg of the solid electrolyte was charged in an insulating outer cylinder and was pressure molded at a pressure of 740 MPa. Subsequently, stainless steel pins were placed on and under the compression-molded ion conductor or compression-molded solid electrolyte. A current collecting lead was attached to each stainless steel pin. Subsequently, the inside of the insulating outer cylinder was sealed and isolated from the outside atmosphere using an insulating ferrule. Finally, the obtained battery was bound from above and below using four bolts, and a surface pressure of 150 MPa was applied to the ion conductor or the solid electrolyte to produce a sample for measuring the ion conductivity. This sample was placed in a thermostat chamber of 25° C. The ion conductivities of the ion conductor and LPS were determined by an electrochemical alternating-current impedance method using a potentiostat/galvanostat (manufactured by Solartron Analytical, 1470E) and a frequency response analyzer (manufactured by Solartron Analytical, 1255B). Based on the obtained results, the ratio (ion conductivity retention rate) of the ion conductivity of ion conductor to the ion conductivity of LPS was calculated. The results are shown in Table 3.

TABLE 3

| | | Ion | Ion |
|---|---|---|---|
| | | conductivity | conductivity |
| | Type of dispersant | (mS/cm) | retention rate (%) |
| Example 1 | Dimethylbutylamine | 5.1 | 106 |
| | (D1506) | | |
| Example 2 | Dimethyloctylamine | 5.1 | 106 |
| | (DM0898) | | |
| Example 3 | Dimethylpalmitylamine | 5.1 | 106 |
| | (DM6098) | | |
| Example 4 | Dimethylbehenylamine | 5.1 | 106 |
| | (DM2285) | | |
| Comparative | #109 | 3.4 | 71 |
| Example 1 | | | |
| Comparative | None | 4.8 | 100 |
| Example 2 | | | |

As shown in Table 3, the ion conductivities of the solid electrolyte compositions according to Examples 1 to 4 were higher than the ion conductivities of the solid electrolyte compositions according to Comparative Examples 1 and 2.

### Measurement of Surface Roughness of Positive Electrode Mixture Layer

A positive electrode mixture layer was produced by the method shown below, and the surface roughness thereof was measured.

First, a positive electrode mixture layer was produced. A positive electrode active material, a solid electrolyte, a binder, a dispersant, a solvent, and a conductive assistant were mixed at a mass ratio of 56.34:14.41:4.73:0.04:23.15:1.33 in an argon glove box with a dew point of −60° C. or less. As the positive electrode active material, lithium nickelate (NCA) was used. As the solid electrolyte, LPS was used. As the solvent, tetralin was used. As the conductive assistant, a vapor grown carbon fibers (manufactured by Resonac Corporation, VGCF) was used. “VGCF” is a registered trademark of Resonac Corporation.

Subsequently, this mixture was dispersed with an ultrasonic homogenizer for 5 minutes to obtain a dispersion. Then, this dispersion was applied to aluminum foil with an applicator or the like and was dried on a hot plate heated to 100° C. for 30 minutes to obtain a positive electrode mixture layer. The surface of the positive electrode mixture layer was observed using a laser microscope (manufactured by KEYENCE, VK-X1000) and an objective lens with 50-times magnification, and the surface roughness was calculated. The observed and obtained surface of the positive electrode mixture layer was divided into four regions, and the surface roughness was measured three times for each region. The surface roughness represents the average of the measurement values. The results are shown in Table 4.

TABLE 4

| | | Surface roughness |
|---|---|---|
| | Type of dispersant | (μm) |
| Example 1 | Dimethylbutylamine (D1506) | 0.59 |
| Example 2 | Dimethyloctylamine (DM0898) | 0.53 |
| Example 3 | Dimethylpalmitylamine (DM6098) | 0.51 |
| Example 4 | Dimethylbehenylamine (DM2285) | 0.50 |
| Comparative | #109 | 0.58 |
| Example 1 | | |

As shown in Table 4, surface roughness was decreased with an increase in the number of carbon atoms of the hydrocarbon group included in the dispersant. It can be understood that the surface smoothness of a solid electrolyte sheet obtained from the solid electrolyte composition can be improved with an increase in the number of carbon atoms of the hydrocarbon group included in the dispersant.

### TG-DTA Measurement of Dispersant

The dispersants used in Examples 2 and 3 and Comparative Example 1 were subjected to simultaneous thermogravimetry-differential thermal analysis (TG-DTA) through the following method. In the TG-DTA analysis, a simultaneous thermogravimetry-differential thermal measurement apparatus (STA2500) manufactured by NETZSCH Japan K.K. was used. In an aluminum pan, 20 mg of a dispersant was placed. The TG-DTA measurement was performed at a temperature rise rate of 10° C./min in a He gas atmosphere. In this measurement, the temperature at which the weight of the dispersant decreased by 1% was measured. The results are shown in Table 5.

TABLE 5

| | Type of dispersant | Temperature (° C.) |
|---|---|---|
| Example 2 | Dimethyloctylamine (DM0898) | 51 |
| Example 3 | Dimethylpalmitylamine (DM6098) | 119 |
| Comparative | #109 | 225 |
| Example 1 | | |

As shown in Table 5, the dispersants in Examples 2 and 3 evaporated at a lower temperature than the dispersant of Comparative Example 1.

The solid electrolyte composition of the present disclosure can be used for manufacturing, for example, an all-solid-state lithium ion secondary battery.

What is claimed is:

1. A solid electrolyte composition comprising:
a solid electrolyte; and
a dialkylamine-based dispersant, wherein
the dialkylamine-based dispersant is represented by a following compositional formula (1): 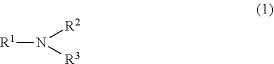
where,
R¹ is hydrocarbon group, and
R² and R³ are each independently an alkyl group having 1 or more and 3 or less carbon atoms.

2. The solid electrolyte composition according to claim 1, wherein
the R¹ is an alkyl group having 8 or more and 22 or less carbon atoms or an alkenyl group having 8 or more and 22 or less carbon atoms.

3. The solid electrolyte composition according to claim 1, wherein
the dialkylamine-based dispersant has a 1% weight loss temperature of lower than 225° C.

4. The solid electrolyte composition according to claim 1, wherein
the solid electrolyte composition further includes a solvent, and
the solid electrolyte is dispersed in the solvent.

5. The solid electrolyte composition according to claim 1, wherein
the solid electrolyte composition further includes a binder, and
the binder includes a styrenic elastomer.

6. The solid electrolyte composition according to claim 5, wherein
the styrenic elastomer includes modified styrene-butadiene rubber.

7. The solid electrolyte composition according to claim 1, wherein
the solid electrolyte has a particulate shape, and
the dialkylamine-based dispersant is placed between multiple particles of the solid electrolyte.

8. The solid electrolyte composition according to claim 1, wherein
the solid electrolyte composition is slurry.

9. An electrode composition comprising:
the solid electrolyte composition according to claim 1, and
an active material.

10. A solid electrolyte sheet comprising:
a solid electrolyte; and
a dialkylamine-based dispersant, wherein
the dialkylamine-based dispersant is represented by a following compositional formula (1): 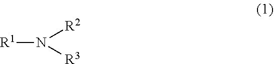
where,
R¹ is a hydrocarbon group, and
R² and R³ are each independently an alkyl group having 1 or more and 3 or less carbon atoms.

11. An electrode sheet comprising:
an active material;
a solid electrolyte; and
a dialkylamine-based dispersant, wherein
the dialkylamine-based dispersant is represented by a following compositional formula (1): 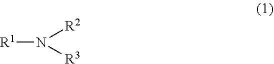
where,
R¹ is a hydrocarbon group, and
R² and R³ are each independently an alkyl group having 1 or more and 3 or less carbon atoms.

12. A battery comprising:
a positive electrode;
a negative electrode; and
an electrolyte layer disposed between the positive electrode and the negative electrode, wherein
at least one selected from the group consisting of the positive electrode, the negative electrode, and the electrolyte layer includes a dialkylamine-based dispersant, and
the dialkylamine-based dispersant is represented by a following compositional formula (1): 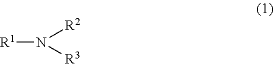
where,
R¹ is a hydrocarbon group, and
R² and R³ are each independently an alkyl group having 1 or more and 3 or less carbon atoms.

13. A method for manufacturing a solid electrolyte composition, comprising
mixing a solid electrolyte and a dialkylamine-based dispersant, wherein
the dialkylamine-based dispersant is represented by a following compositional formula (1): 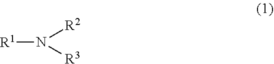
where,
R¹ is a hydrocarbon group, and
R² and R³ are each independently an alkyl group having 1 or more and 3 or less carbon atoms.
